(19) United States
(12) Patent Application Publication
(10) Pub. No.: US 2008/0195881 A1
(43) Pub. Date: Aug. 14, 2008

(54) Method and apparatus for providing on-demand backup power for an optical network terminal

(76) Inventors: Marc R. Bernard, Miramar, FL (US); Douglas A. Atkinson, Ashburn, VA (US); Michael Giovannoni, Great Falls, VA (US); Joseph C. Roesch, Herndon, VA (US); John A. Stock, Leesburg, VA (US); Jeffrey A. Rosenwald, Frederick, MD (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/001,237

(22) Filed: Dec. 11, 2007

Related U.S. Application Data
(60) Provisional application No. 60/900,892, filed on Feb. 12, 2007.

(51) Int. Cl. G06F 11/30; G06Q 30/00

(52) U.S. Cl. 713/340; 705/34; 705/40

(57) ABSTRACT

There is demand in the marketplace for smaller optical network devices, such as Optical Network Terminals (ONTs). As a result of decreasing the ONT's size, the size of the backup power source, such as the batteries that power the ONT during periods of back-up power usage, may also have to be reduced. To extend energy usage of the backup power source, methods and corresponding apparatus for providing backup power for a network device are provided. An example method includes entering a first state of backup power in an event of a loss of primary power to an ONT, monitoring a state of a backup power activation signal enabled to be activated in the event of the loss of primary power to the ONT, and causing the ONT to enter a second state of backup power in response to the backup power activation signal being in an active state.

### RELATED APPLICATIONS

This application claims the benefit of U.S. Provisional Application No. 60/900,892, filed on Feb. 12, 2007. The entire teachings of the above application are incorporated herein by reference.

### BACKGROUND OF THE INVENTION

An Optical Network Terminals (ONT) is an example of a network node that has a battery backup power source to support communications for end-users in an event a primary power source is interrupted. As ONT's decrease in size, the size of the backup power source, such as the batteries that power the ONT during periods of back-up power usage, may also be reduced. Smaller batteries, however, typically cannot support the length (e.g., eight hours) of backup power required of telecommunications (“Telecom”) service providers for use of emergency dial-out service, for example.

### SUMMARY OF THE INVENTION

A method and corresponding apparatus of providing backup power for an Optical Network Terminal (ONT), in a Passive Optical Network (PON) in accordance with an embodiment of the present invention, is provided. An example embodiment includes (1) entering a first state of backup power in an event of a loss of primary power to an ONT; (2) monitoring a state of a backup power activation signal enabled to be activated in the event of the loss of primary power to the ONT; and (3) causing the ONT to enter a second state of backup power in response to the backup power activation signal being in an active state.

In another embodiment, a method is provided for offering multiple service plans to an end-user for services available during an ONT being in a state of backup power. The method associates at least one backup power level with a respective at least one service based on a battery back-up service plan selected by an end-user. A fee corresponding to the battery back-up service plan selected by the end-user is collected by a service provider.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-1B are network diagrams of example Passive Optical Network (PON) employing embodiments of the present invention;

FIG. 2 is an example flow diagram performed in accordance with an embodiment of the present invention;

FIGS. 3A-3C are block diagrams of example Optical Network Terminals (ONTs) in accordance with embodiments of the present invention;

FIGS. 4A-4C are block diagrams of example Optical Network Terminals (ONTs) in accordance with another embodiment of the present invention;

FIG. 5 is an example flow diagram performed in accordance with another example embodiment of the present invention;

FIGS. 6A-6B are block diagrams of example Optical Network Terminals (ONTs) and Customer Premises in accordance with embodiments of the present invention;

FIGS. 7-9 are example flow diagrams performed in accordance with yet other example embodiments of the present invention;

FIG. 10 is an example diagram of the various backup power states versus time or event in accordance with an embodiment of the present invention;

FIG. 11 is an example flow diagram performed in accordance with yet another example embodiment of the present invention;

FIG. 12 is an example billing statement in accordance with an embodiment of the present invention;

FIG. 13 is another example billing statement in accordance with another embodiment of the present invention; and

FIGS. 14A-14C are example service plans in accordance with embodiments of the present invention.

### DETAILED DESCRIPTION OF THE INVENTION

A description of example embodiments of the invention follows.

An ONT typically uses a significant amount of power to support communications using certain technologies, such as Plain Old Telephone Service (POTS) and Multimedia over Coax Alliance (MoCA). There are some situations, such as long-term power outages, where the eight hour requirement, for example, is insufficient for maintaining telecommunications services to a customer. In these situations, the backup power requirement may be days rather than hours.

A way to use smaller batteries to meet a long-term power requirement while achieving the design requirement of smaller ONTs is to minimize battery usage. A method and corresponding apparatus for providing backup power for an optical network device, such as an ONT in a Passive Optical Network (PON), are provided. An example method includes entering a first state of backup power in an event of a loss of primary power to an ONT, monitoring a state of a backup power activation signal enabled to be activated in the event of the loss of primary power to the ONT, and causing the ONT to enter a second state of backup power in response to the backup power activation signal being in an active state.

In the first state of backup power, the ONT may provide only particular services, such as POTS and DATA. In the second state of backup power, the ONT may provide only another particular type of service, such as DATA. There may be more than two states of backup power, including an emergency dial-out only state, such as a 9-1-1 call service state.

The end-user may select the particular type of services that are associated with each state of backup power via, for example, a graphical user interface (GUI) on the ONT. The service provider may also include default services installed at the manufacturing facility. The particular type of services may also be fixed in a particular version of software. In the first, second, or other state, such as a third state, of backup power, the ONT is configured to use backup power for a configurable amount of time before entering a power OFF mode. This time can be configured by the manufacturer or by the end-user via a configurable interface, such as a graphical user interface, supporting the ONT.

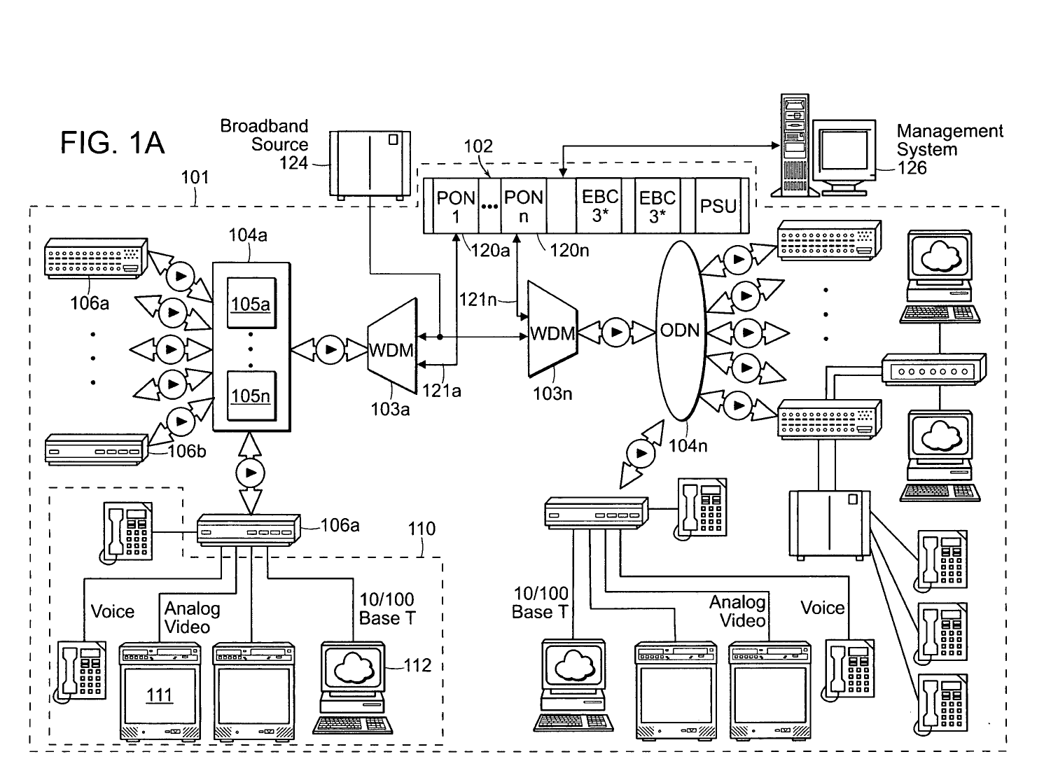

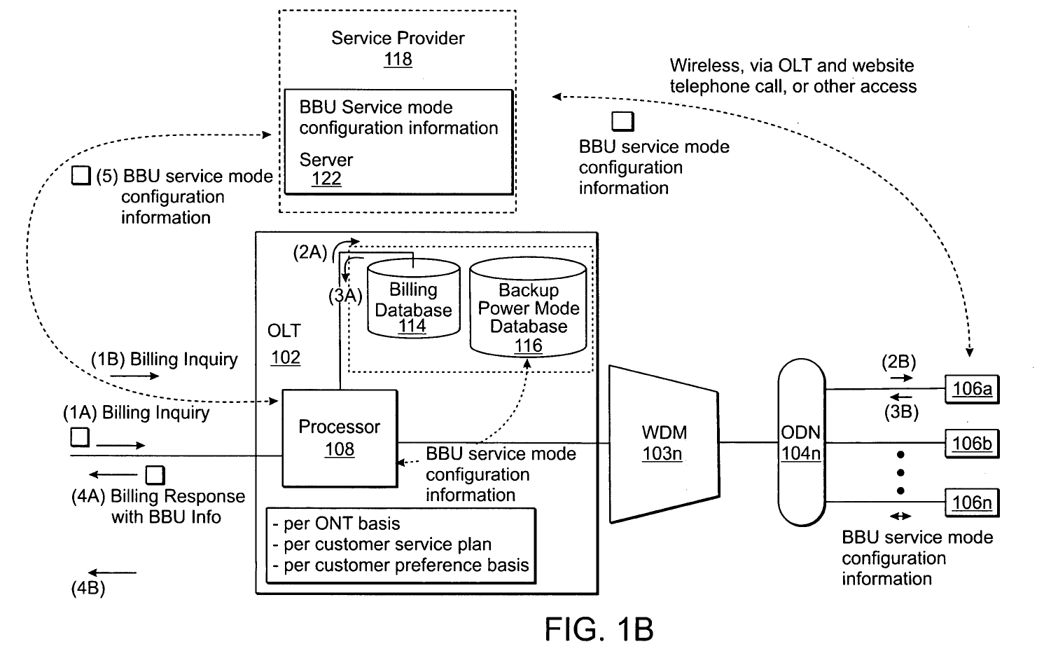

FIG. 1A is a network diagram of an example Passive Optical Network (PON) 101 employing embodiments of the present invention. The PON 101 includes an Optical Line Terminal (OLT) 102, Wavelength Division Multiplexers (WDMs) 103a, . . . , 103n, Optical Distribution Network (ODN) devices 104a, . . . , 104n, ODN device splitters (e.g., ODN device splitters 105a, . . . , 105n associated with ODN device 104a), Optical Network Terminals (ONTs) (e.g., 106a, 106b, . . . , 106n corresponding to ODN device splitters 105a, . . . , 105n), and customer premises equipment (e.g., 110). The OLT 102 includes PON cards 120a, . . . , 120n which provide corresponding optical feeds 121a, . . . , 121n to respective ODN devices 104a, . . . , 104n. Optical feed 121a, for example, is distributed through corresponding ODN device 104a by separate ODN device splitters 105a, . . . , 105n to respective ONTs 106a, 106b, . . . , 106n in order to provide communications to and from customer premises equipment 110.

The PON 101 may be deployed for fiber-to-the-business (FTTB), fiber-to-the-curb (FTTC), and fiber-to-the-home (FTTH) applications. The optical feeds 121a, . . . , 121n in the PON 101 may operate at bandwidths such as 155 megabits per second (Mb/s), 622 Mb/s, 1.25 gigabits per second (Gb/s), and 2.5 Gb/s or any other desired bandwidth implementations. The PON 101 may incorporate asynchronous transfer mode (ATM) communications, broadband services such as Ethernet access and video distribution, Ethernet point-to-multipoint topologies, and native communications of data and time division multiplexing (TDM) formats. Customer premises equipment (e.g., 110) that can receive and provide communications in the PON 101 may include standard telephones (PSTN and cellular), Internet Protocol telephones, Ethernet units, video devices (e.g., 111), computer terminals (e.g., 112), digital subscriber line connections, cable modems, wireless access, as well as any other conventional device.

The PON 101 may include one or more different types of ONTs (e.g., 106a, 106b, . . . , 106n). Each ONT 106a, 106b, . . . , 106n, for example, communicates with an ODN device 104a through associated ODN device splitters 105a, . . . , 105n. Each ODN device 104a, . . . , 104n in turn communicates with an associated PON card 120a, . . . , 120n through respective WDMs 103a, . . . , 103n. Communications between the ODN devices 104a, . . . , 104n and the OLT 102 occur using a downstream wavelength and an upstream wavelength. The downstream communications from the OLT 102 to the ODN devices 104a, . . . , 104n may be provided at 622 Mb/s, which is shared across all ONTs connected to the ODN devices 104a, . . . , 104n. The upstream communications from the ODN devices 104a, . . . , 104n to the PON cards 120a, . . . , 120n may be provided at 155 Mb/s, which is shared among all ONTs connected to the ODN devices 104a, . . . , 104n.

A broadband source 124, of which a cable television feed through an Erbium Doped Fiber Amplifier (EDFA) is just one example, may provide video or other broadband data to the WDMs 103a, . . . , 103n using a single wavelength (hereinafter, video wavelength). The WDMs 103a, . . . , 103n multiplex the PON upstream and downstream communications wavelengths and the video wavelength and provide the resulting multiplexed signals to respective ODN devices 104a, . . . , 104n. Each ONT (e.g., 106a, 106b, . . . , 106n) may monitor a broadband overlay signal provided by the broadband source 124. One example of a broadband overlay signal is a 1550 nanometer signal used for downstream analog video applications.

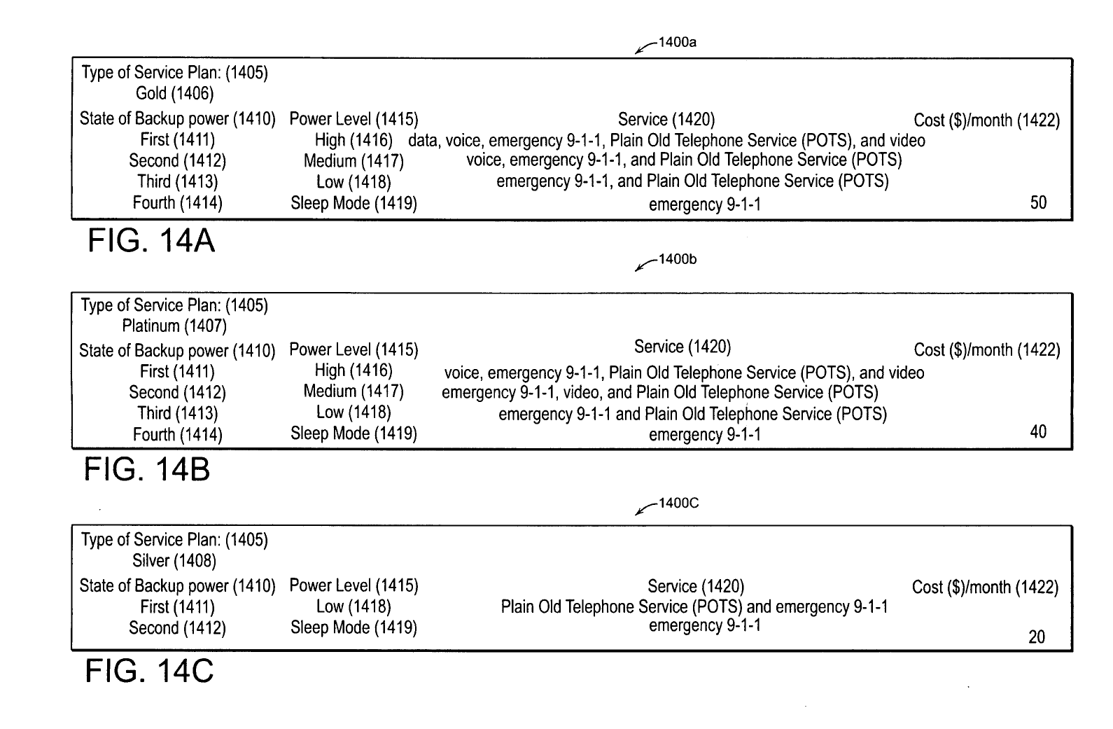

FIG. 1B is a more detailed network diagram of an example Passive Optical Network (PON) 101 in accordance with an example embodiment of the present invention. The PON 101 may include a service provider 118 providing Ethernet, Wi-Fi, Very-high-bit-rate Digital Subscriber Line (VDSL), Home Phone Line Networking Alliance (HPNA), Plain Old Telephone Service (POTS), Home Plug Power Line Alliance, Multi-media over Coax Alliance (MoCA), wireless, and other home network solutions. The service provider 118 includes a server 122 storing battery backup unit (BBU) service mode configuration information. The BBU service mode configuration information includes at least one level of secondary end-user service and service plans as discussed in FIGS. 14A-14C. The BBU service mode configuration information may be on a per ONT basis (e.g., 106a, 106b, . . . , 106n), per customer service plan (e.g., FIGS. 14A-14C), per customer preference basis. The customer preference basis may be a service set-up that the end-user may define in real-time, for example, at the ONT 106a, 106b, . . . , 106n, thus may over-ride the customer service plan. The BBU service mode configuration information may be defined locally at the ONT (e.g., 106a, 106b, . . . , 106n), remotely via a wireless connection, remotely or locally via the service provider (e.g., 118), or any combinations thereof. The end-user may define the BBU service mode configuration information by using a website, making a telephone call to the service provider, or utilizing other type of access points. The BBU service mode configuration information may be stored in a backup power mode database 116 of the OLT 102 and/or the ONT 106a, 106b, . . . , 106n.

The OLT 102 may further include a processor 108 and a billing database 114. The processor 108 may process at least one billing inquiry associated with the BBU service mode configuration information. The billing database 114 may be in communication with the processor 108 to store at least one billing statement. The billing database 114 and the backup power mode database 116 may be one single database or separate databases.

The service provider 118, for example, may initiate a billing inquiry via at least two paths. The first path for the billing inquiry is to the OLT 102. The OLT 102 may respond to the billing inquiry with BBU information. In this example embodiment, the second path for the billing inquiry is to the ONT 106a, 106b, . . . , 106n via the OLT 102. The ONT 106a, 106b, . . . , 106n may respond to the billing inquiry with the BBU information.

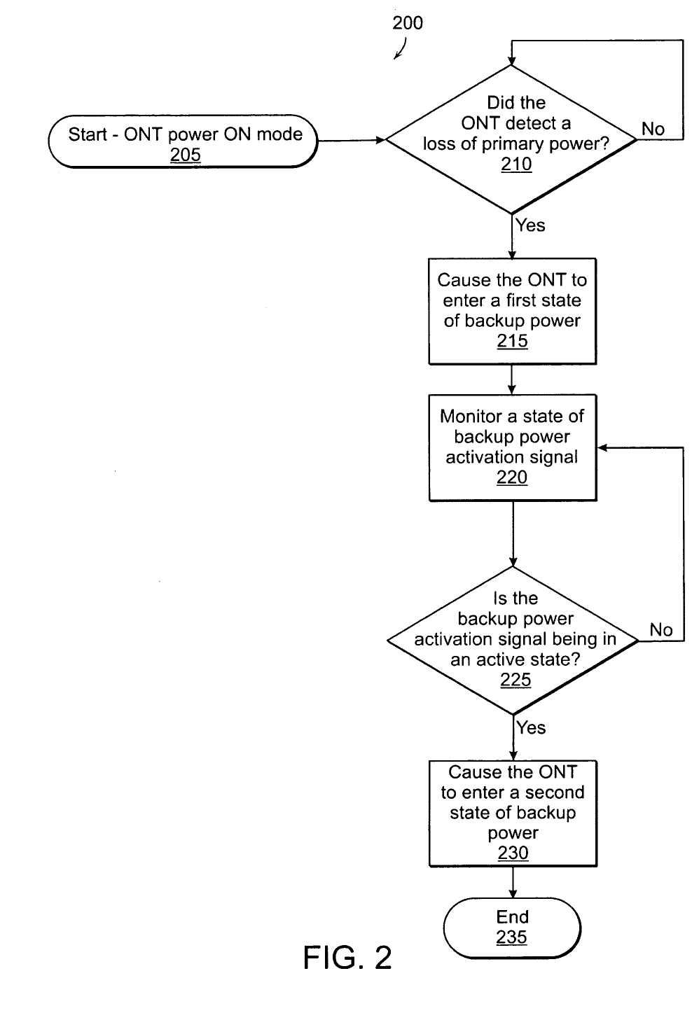

FIG. 2 is an example flow diagram 200 performed in accordance with an example embodiment of the present invention. The flow diagram starts after an ONT initially enters a power ON mode (205), typically with primary AC power applied. The ONT may determine whether it has detected a loss of power connection (210). The power ON mode may be when the ONT is utilizing a primary power source rather than the backup power source. The primary power source may be, for example, a power connection to a source (e.g., a wall outlet) providing power in the form of alternating current (AC) supplied to the ONT by the power company. The power may also be in the form of direct current (DC). It should be understood that the power connection may be made by a power cord from the ONT plugged into the primary power source, such as an electrical socket.

If the ONT has not detected the loss of power connection, the ONT continues to operate while detecting whether a loss of power connection has occurred (210). However, if the ONT detects a loss of power connection, the ONT enters the first state of backup power (215). The first state of backup power, for example, may be a state in which the ONT provides only a particular service, such as POTS, according to battery backup unit (BBU) service mode configuration. The end-user may select other services via, for example, a graphical user interface (GUI) on the ONT. The service provider may also include other default services installed at the manufacturing facility.

Next, the ONT may monitor a state of backup power activation signal (220). The backup power activation signal may be an event driven signal (e.g., on-demand request or interrupt) or a timing signal. The ONT may then determine if the backup power activation signal is in an active state (225). If the backup power activation signal is not in an active state, the ONT continues to monitor the state of backup power signal (220). If the backup power activation signal is in an active state, the ONT enters the second state of backup power (230) and then ends (235). The second state of backup power, for example, may be a state in which the ONT provides only another particular type of service, such as DATA, according to the BBU service mode configuration. The end-user may select other services via a graphical user interface (GUI) (not shown) on the ONT. The service provider may also include other default services installed at the manufacturing facility.

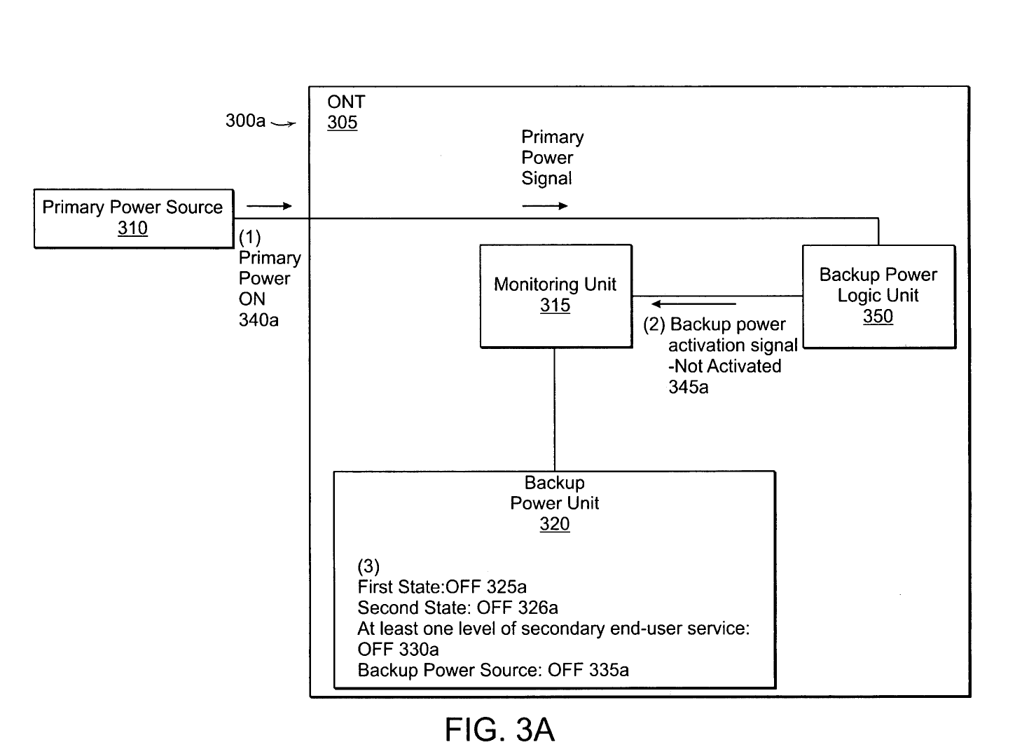

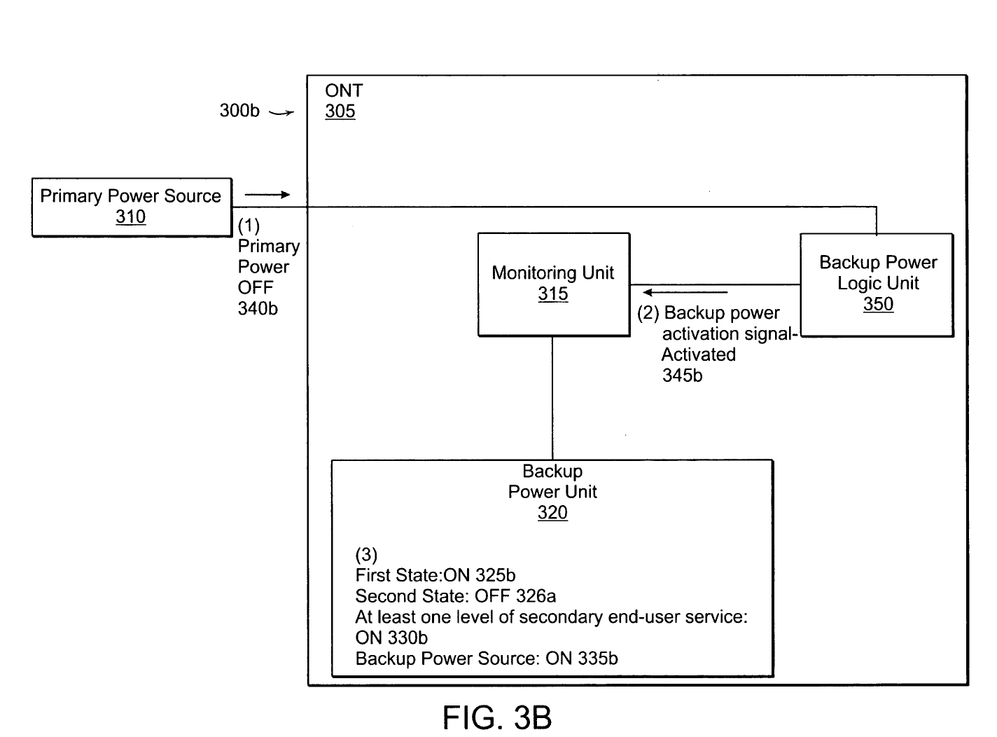

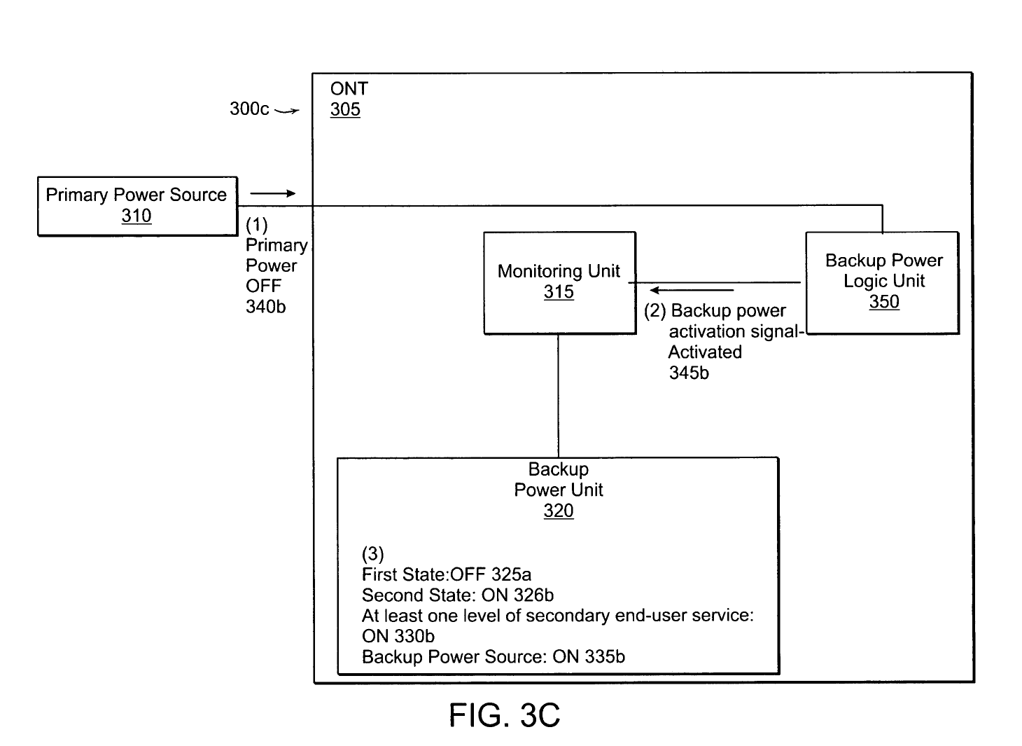

FIGS. 3A-3C are block diagrams of example Optical Network Terminals (ONTs) 300a, 300b, 300c according to embodiments of the present invention. In FIG. 3A, the ONT 305 includes a monitoring unit 315, backup power unit 320, and backup power logic unit 350. The ONT 305 may connect to a primary power source 310. The backup power unit 320 may include at least one battery. The backup power unit 320 may be external from the ONT 305 or integrated as part of the ONT 305. The backup power unit 320 may be connected to the ONT 305 through any form of wiring. The backup power logic unit 350 may send a backup power activation signal 345a, 345b enabled to be activated in an event of a loss of primary power to the ONT 305. The monitoring unit 315 may monitor a state of the backup power activation signal 345a, 345b. The monitoring unit 315 may cause the backup power unit 320 to enter a first state of backup power 325a, 325b, in response to the backup power activation signal 345a, 345b being in an active state.

The ONT 305 may support technologies such as Ethernet, Wi-Fi, Very-high-bit-rate Digital Subscriber Line (VDSL), Home Phone Line Networking Alliance (HPNA), Plain Old Telephone Service (POTS), Home Plug Power Line Alliance, Multi-media over Coax Alliance (MoCA), wireless, and other home network solutions.

Typically, when an end-user purchases communications services, he may contact a service provider and request the communications services. The service provider may then dispatch a technician to the end-user's premises to install the ONT 305 or to set-up communications services on an already installed ONT 305. Before or after the technician installs the ONT 305, the service provider may provision the ONT 305 with configuration information, including the serial number of the ONT 305 and a setting to enable a default communications service or a specific communications service based on information known to the service provider or provided by the end-user. For example, the service provider may use a management system (not shown) to configure the ONT 305 with a default communications service, such as POTS.

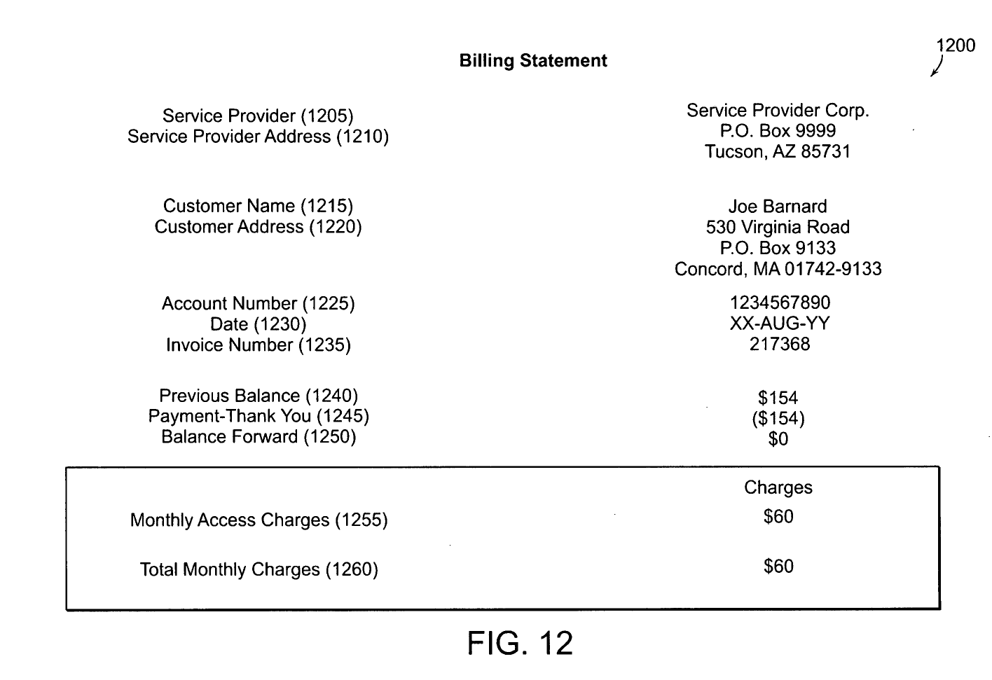

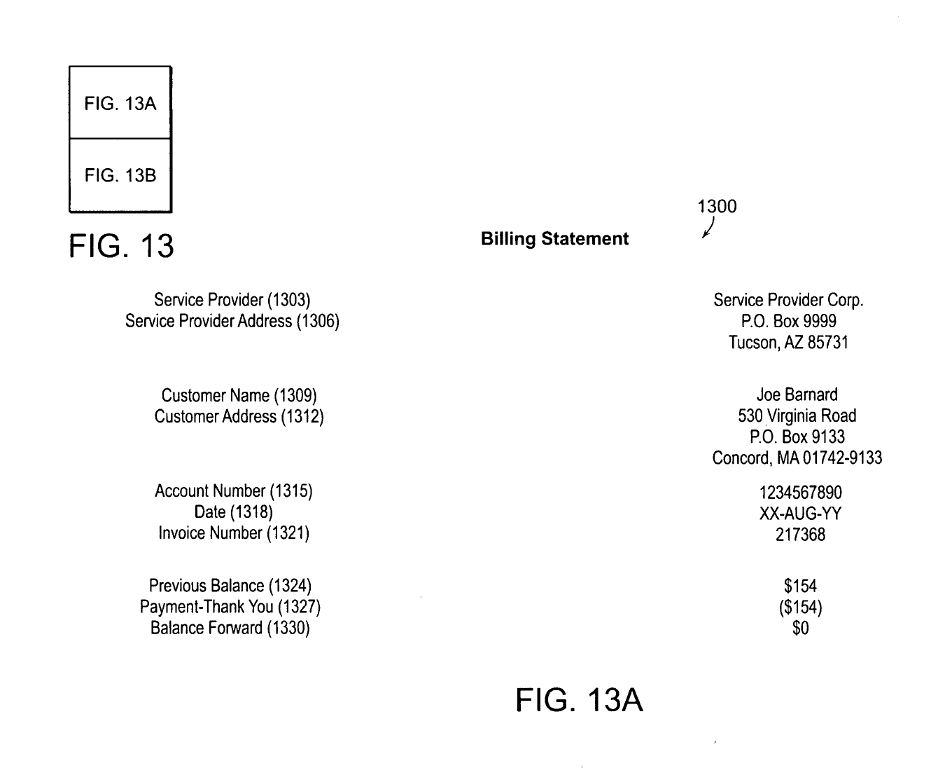

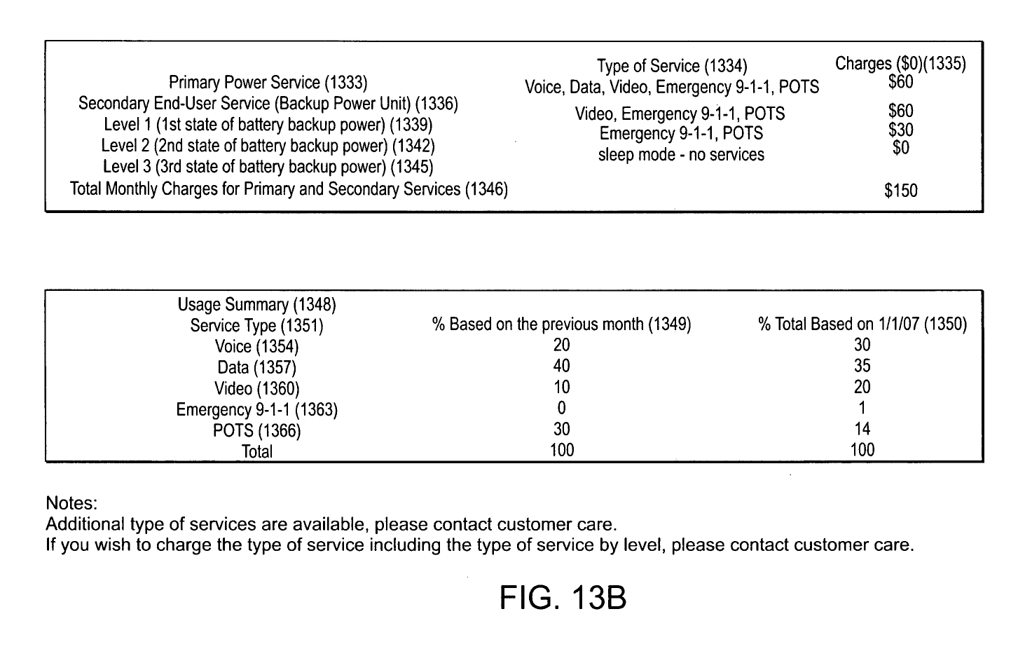

As illustrated in FIG. 3A, typically the ONT 305 receives primary power 340a by plugging an electrical cord (not shown) into a primary power source 310, such as a wall socket, at the end-user's premises. While the primary power source 310 provides sufficient power, the backup power unit 320 is in an OFF state 335a. The ONT 305 may also have the first state of backup power 325a and second state of backup power 326a in the OFF state. The first state of backup power 325a, 325b, for example, may be a state in which the ONT 305 provides at least one level of secondary end-user service 330a, 330b, such as DATA, voice, emergency 9-1-1 service, POTS, and video. The second state of backup power 326a, 326b, for example, may be a state in which the ONT 305 provides a second level of the at least one level of secondary end-user service 330a, 330b, such as DATA and emergency 9-1-1 service. The end-user may select the at least one level of secondary end-user service 330a, 330b via a graphical user interface (GUI) (not shown) on the ONT. The service provider may also include other default services installed at the manufacturing facility. Battery backup unit (BBU) service mode configuration information may include at least one level of secondary end-user service 330a, 330b and the charges or billings associated with the at least one level of secondary end-user service 330a, 330b as shown, for example, billing statements of FIGS. 12 and 13.

While the ONT 305 is using primary power 340a, the backup power logic unit 350 may send a backup power activation signal 345a enabled to be activated in an event of a loss of primary power to the ONT 305. Since there is no loss in primary power, the backup power logic unit 350 does not activate the backup power activation signal 345a.

However, the end-user's premises may experience a loss of power for many reasons, such as a malfunctioning transformer connected to the end-user's premises. In these situations, the backup power unit 320 may supply power to the ONT 305. In some of today's networks, the standard defined by Telecom service providers suggests that the backup power unit 320 is to have at least eight hours of backup power to the ONT 305.

As illustrated in FIG. 3B, there is a loss of power 340b between the ONT 305 and the primary power source 310, which may be caused by a cable or wire cut, blackout condition, or other source of interruption in primary power. Once the ONT 305 detects the loss of power 340b, the backup power logic unit 350 may send and enable the backup power activation signal to be in an active state 345b. In response to monitoring the state of the backup power activation signal and determining it is in the active state 345b, the monitoring unit 315 may cause the backup power unit 320 to enter a first state of backup power 325b, if the backup power activation signal is activated 345b by the backup power logic unit 350. The first state of backup power 325b, for example, may be a state in which the ONT 305 provides only a particular service, such as POTS and DATA. The ONT 305 remains in the first state of backup power 325b until the monitoring unit 315 senses a backup power activation signal 345b is in an active state.

As illustrated in FIG. 3C, the ONT 305 enters the second state of backup power 326b because the monitoring unit 315 senses a backup power activation signal 345b in an active state. The second state of backup power 326b, for example, may be a state in which the ONT provides only a particular type of service, such as DATA.

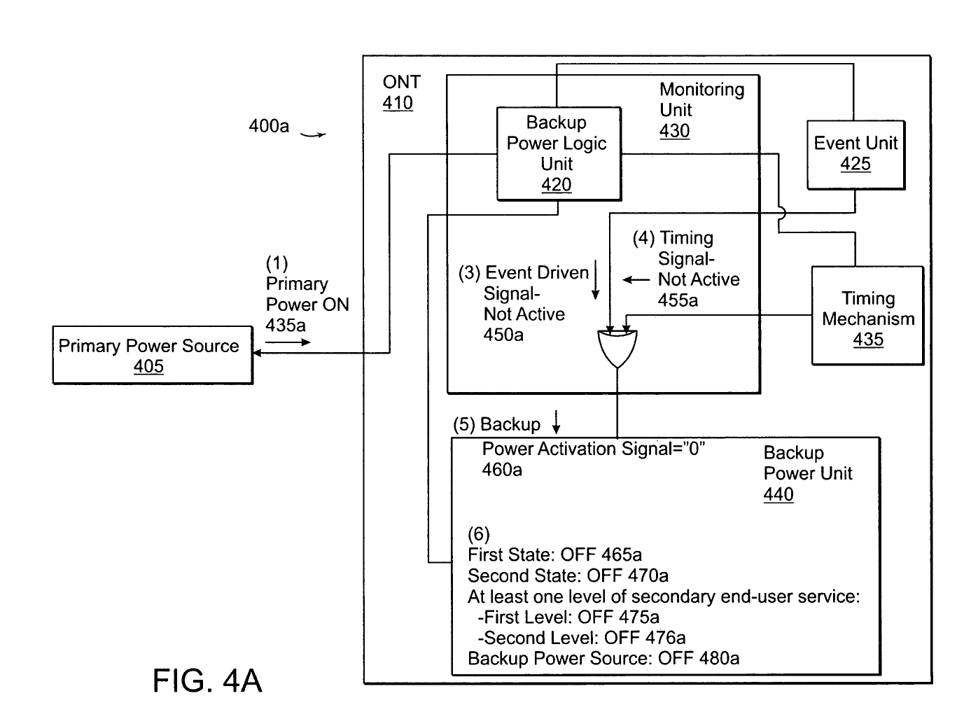

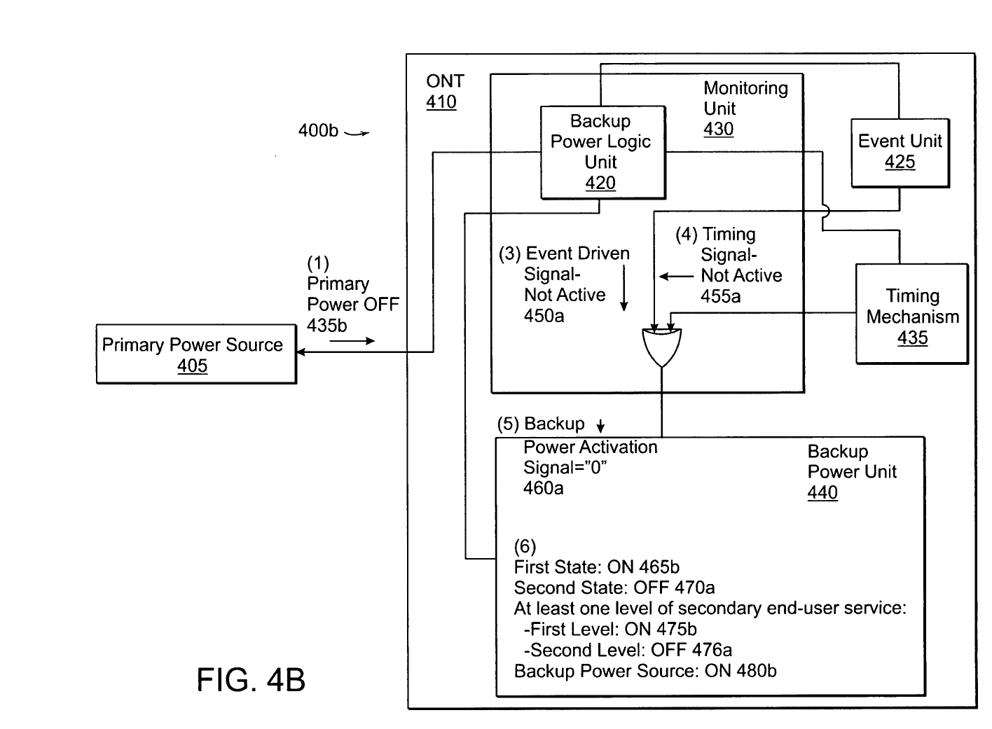

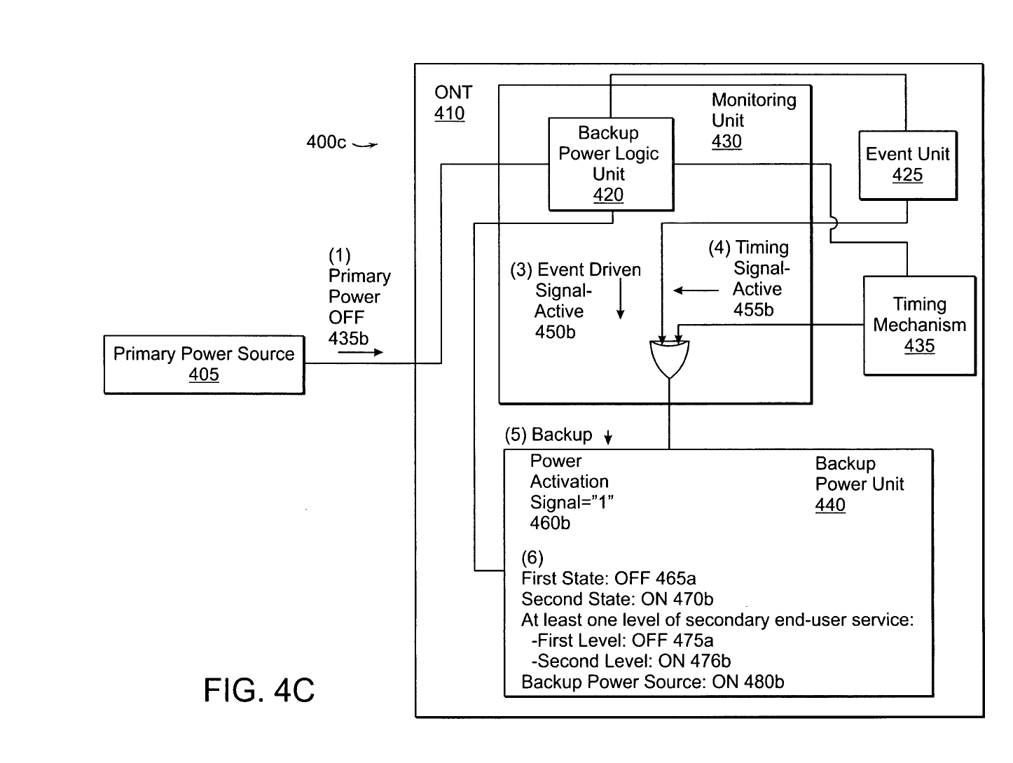

FIGS. 4A, 4B, and 4C are block diagrams of example Optical Network Terminals (ONTs) 400a, 400b, 400c according to example embodiments of the present invention. In FIG. 4A, the ONT 410 includes a monitoring unit 430, backup power unit 440, event unit 425, and timing mechanism 435. The monitoring unit 430 may include a backup power logic unit 420 to detect the loss of primary power 435b to the ONT 410. The backup power logic unit 420 may cause the backup power unit 440 to provide backup power in an event of a loss of primary power 435b. The backup power logic unit 420 may be within the monitoring unit 430 or separate from the monitoring unit 430 but within the ONT 410. The ONT 410 may connect to a primary power source 405. The backup power unit 440 may include at least one battery. The backup power unit 440 may be external from the ONT 410 or a sub-part of the ONT 410. The backup power unit 440 may be connected to the ONT 410 through any form of wiring.

As illustrated in FIG. 4A, typically the ONT 410 receives power 435a by plugging an electrical cord (not shown) into a primary power source 405, such as a wall socket, at the end-user's premises. While the primary power source 405 provides sufficient power, the backup power unit 440 is in an OFF state 480a. The ONT 410 may also have a first state of backup power 465a (“first state”) and second state of backup power 470a (“second state”) with ON and OFF states. While the primary power is active 435a, the first state 465a and second state 470a are in OFF states. Unless otherwise specified, being in one of the first or second states means the particular state is in the ON state and the other state (i.e., second or first state, respectively) is in the OFF state. The first state of backup power 465a, for example, may be a state in which the ONT provides only a particular service, such as POTS, according to the BBU service mode configuration information. The second state of backup power 470a, for example, may be a state in which the ONT provides only another particular type of service, such as DATA or emergency dial-out service according to the BBU service mode configuration information. The end-user may select other services via a graphical user interface (GUI) on the ONT. The service provider may also include other default services installed at the manufacturing facility.

While the ONT 405 is using primary power 435a, the backup power activation signal 460a is not in an active state because an event driven signal 450a or a timing signal 455a is not active. However, the end-user's premises may experience a loss of power for many reasons, such as a malfunctioning transformer connected to the end-user's premises. In these situations, the backup power unit 440 may supply power to the ONT 405. In some of today's networks, the standard defined by Telecom service providers suggests that the backup power unit 440 is to have at least eight hours of backup power to supply the ONT 410.

As illustrated in FIG. 4B, there is a loss of primary power 435b between the ONT 410 and the primary power source 405, possibly due to a cable or wire cut, blackout condition, or other source of interruption in primary power. Once the backup power logic unit 420 detects the loss of primary power 435b, the backup power logic unit 420 may send a signal to the backup power unit 440 to cause the backup power unit 440 to be ON 480b. The monitoring unit 430 may cause the ONT 410 to enter the first state of backup power 465b. The first state of backup power 465b, for example, may be a state in which the ONT 410 provides only a particular service, such as data, voice, emergency 9-1-1 service, POTS, and video, according to the BBU service mode configuration information. The timing mechanism 435 may time a duration of the ONT's 410 being in the first state of backup power 465b. The ONT 410 remains in the first state of backup power 465b until the monitoring unit 430 senses an event driven signal 450b or timing signal 455b being in an active state.

As illustrated in FIG. 4C, the ONT 410 enters the second state of backup power 470b because the monitoring unit 430 senses the event driven signal 450b or timing signal 455b being in the active state. The second state of backup power 470b, for example, may be a state in which the ONT 410 provides only another particular type of service, such as DATA, according to the BBU service mode configuration information. The ONT 410 may enter the second state of backup power 470b in at least two ways.

One way for the ONT 410 to enter the second state of backup power 470b is when the timing mechanism 435 reaches a terminal threshold. As illustrated in FIG. 4B, the timing mechanism 435 may time a duration of the ONT's 410 being in the first state of backup power 465b after entering the first state of backup power 465b. The timing mechanism 435 may send a timing signal 455b in the active state to the monitoring unit 430 in response to the duration reaching the terminal threshold. The timing mechanism 435 may cause the backup power activation signal 460b to enter the active state as a function of a timing signal 455b. The monitoring unit 430, in turn, may send the backup power activation signal 460b to cause the backup power unit 440 to enter a second state of backup power 470b in response to the timing signal 455b being in the active state.

In this example embodiment, the terminal threshold may be a numerical value or logical setting. The terminal count may be configured by the end-user via a graphical user interface (GUI) (not shown) on the ONT 410. Alternatively, the monitoring unit 430 may cause the backup power unit 440 to enter the second state of backup power 470b irrespective of activity by an end-user at the ONT 410. For example, the terminal count may be a default value loaded at the manufacturer's facility. The timing mechanism 435 may be any form of timing mechanism, such as a count up timer, count down timer, clock with logic, and so forth.

Another way for the ONT 410 to enter the second state of backup power 470b may result from the event unit 425 being activated. The event unit 425 may include a power state button (not shown) to trigger the event driven signal 450b to enter the active state. The event unit 425 may be activated by a technician or end-user triggering a power state button (not shown). The power state button (not shown) may be triggered by a mechanical switch, electrical switch, software-based switch, logical switch, or any combination thereof.

In response to the power state button (not shown) being activated, the event unit 425 may send an event driven signal 450b in an active state to the monitoring unit 430. The event unit 425 may cause the backup power activation signal 460b to enter the active state as a function of an event driven signal 450b. The monitoring unit 430, in turn, may send the backup power activation signal in the active state 460b to cause the backup power unit 440 to enter a second state of backup power 470b in response to the event driven signal 450b being in the active state. The event unit 425 may be activated by a technician entering a specific sequence of digits in his or her telephone or through any other physical or logical medium.

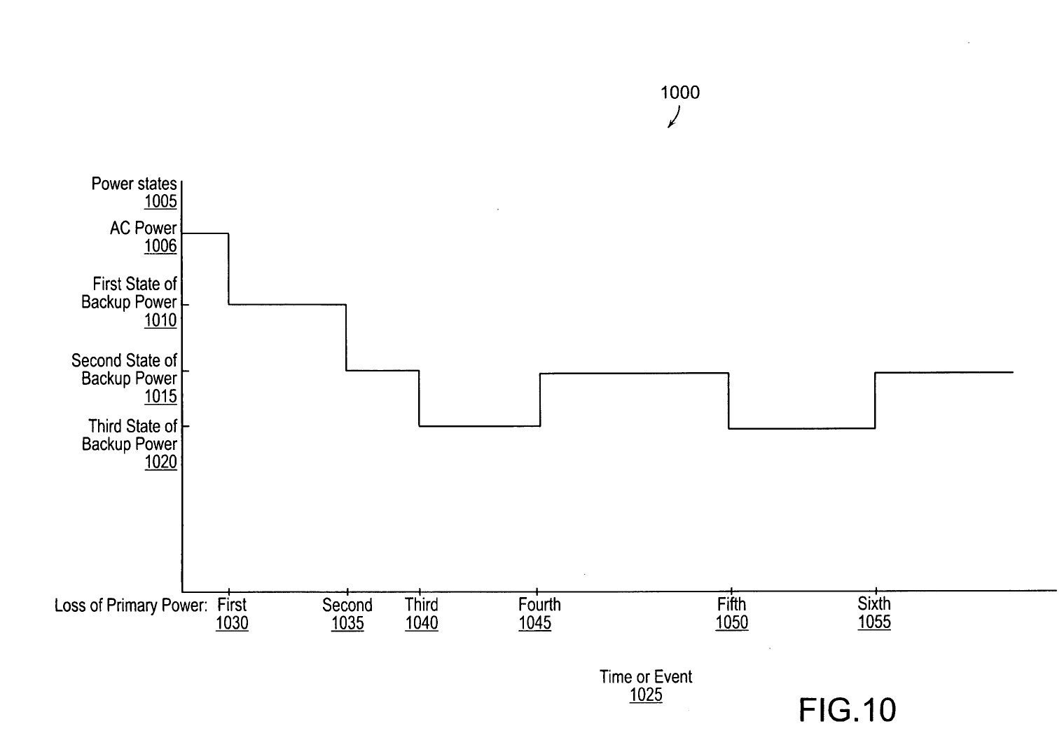

Although FIGS. 4A-4C show a first state and second state of backup power 465a, 465b, 470a, 470b, it should be understood that the monitoring unit 430 may cause the backup power unit 440 to enter at least one third state of backup power in response to the backup power activation signal 460b being in the active state. Moreover, the monitoring unit 430 may change backup power states upward in the backup power states and to change a level of at least one level of secondary end-user service according to the BBU service mode configuration information in response to other events. This is further discussed in reference to FIG. 10, which shows the various backup power states versus time or event in accordance with an example embodiment of the present invention.

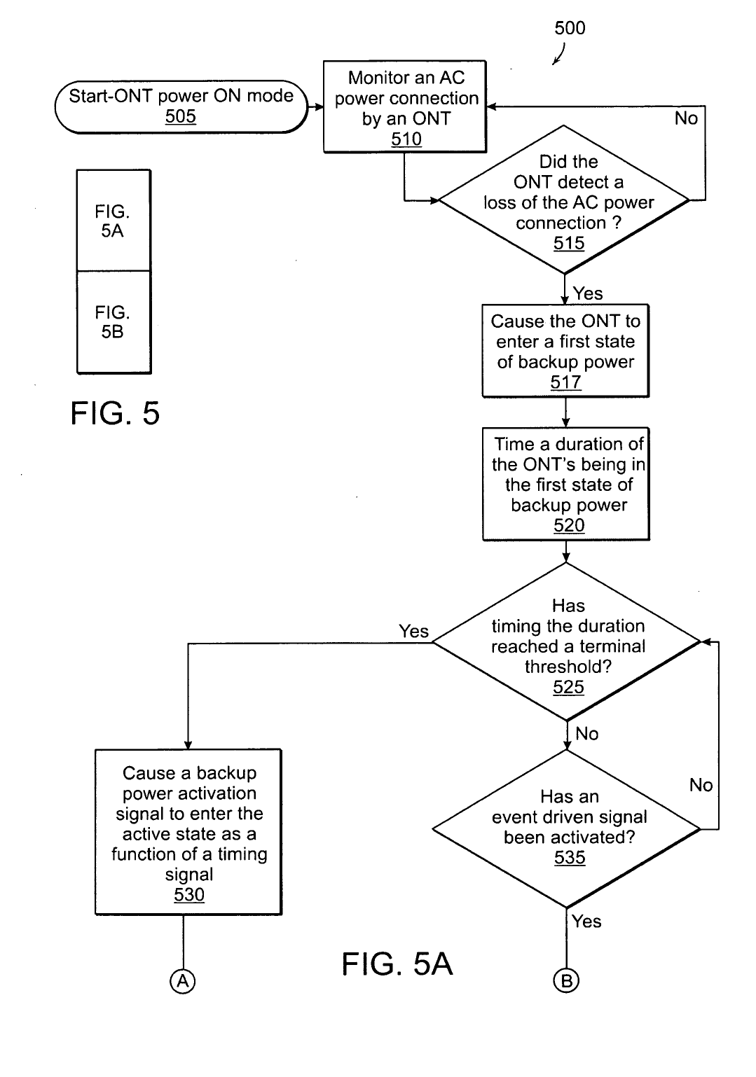

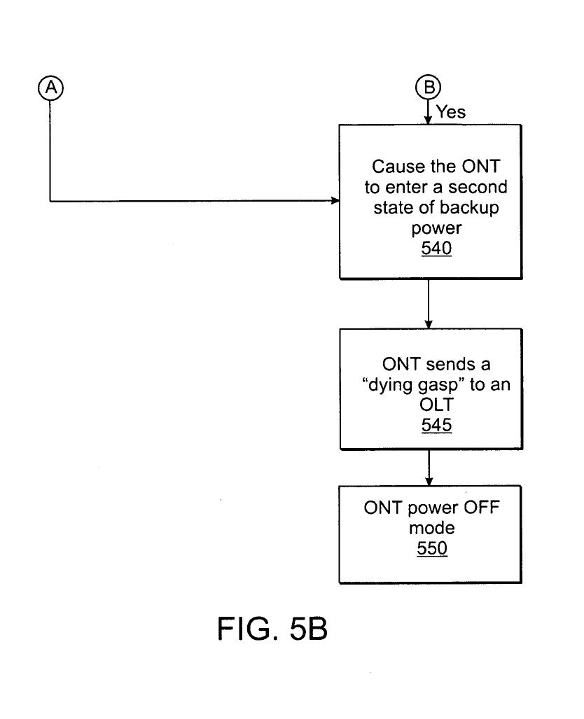

FIG. 5 is an example flow diagram 500 performed in accordance with an example embodiment of the present invention. After an ONT initially enters a power ON mode (505), the ONT may monitor for a power connection (510). The power connection may be alternating current (AC) supplied to the ONT by the power company. The power may also be in the form of direct current (DC). The power connection may be made by the ONT's having a power cord plugged into an electrical socket. The ONT may then determine whether it has detected a loss of power connection (515). If the ONT has not detected the loss of power connection, the ONT continues to monitor the power connection (510). However, if the ONT detects the loss of power connection (515), the ONT may enter the first state of backup power (517). The first state of backup power, for example, may be a state in which the ONT provides only a particular service, such as POTS. The end-user may select other services via a graphical user interface (GUI) on the ONT. The service provider may also include other default services installed at the manufacturing facility.

The ONT may time the duration of the ONT's being in the first state of backup power (520). Next, the ONT determines whether the timing of the duration of the ONT's being in the first state of backup power reaches a terminal threshold (525). If the ONT reaches the terminal threshold, the ONT causes a backup power activation signal to enter an active state (530). The backup power activation signal, for example, may be an Emergency Power (EPWR) activation signal that is internal to the ONT. The ONT may then send a “dying gasp” command to the Optical Line Terminal (OLT) (545). The “dying gasp” command may be a command in a Physical Layer Operations, Administration and Maintenance (PLOAM) message.

If the ONT has not reached the terminal threshold (525), the ONT determines whether an event driven signal is an active state (535). The event driven signal is in the active state when an event unit is triggered. The event unit may be triggered by a power state button. The power state button may be triggered by a mechanical switch, electrical switch, software-based switch, logical switch, or any combination thereof. If the event driven signal is not in the active state, the ONT continues to determine whether the timing of the duration of the ONT's being in the first state of backup power reaches the terminal threshold (525). If the event driven signal is in the active state, the ONT enters the second state of backup power (540). The second state of backup power, in this embodiment, is the ONT's being in the power OFF mode. The power OFF mode, however, may continue to support emergency dial-out service. The ONT may enter the second state of backup power irrespective of activity by an end-user at the ONT. For example, the end-user may not have a choice in defining the terminal threshold. The customer preference may define the type of services in real time, but in other embodiments, the end-user may not be able to define the type of services in real time. The type of services in such a situation, may be defined by the manufacturer or the service provider, irrespective of the activity by the end-user at the ONT. In this embodiment, the ONT may then send a “dying gasp” to the Optical Line Terminal (OLT) (545) prior to the ONT turning its power off (550).

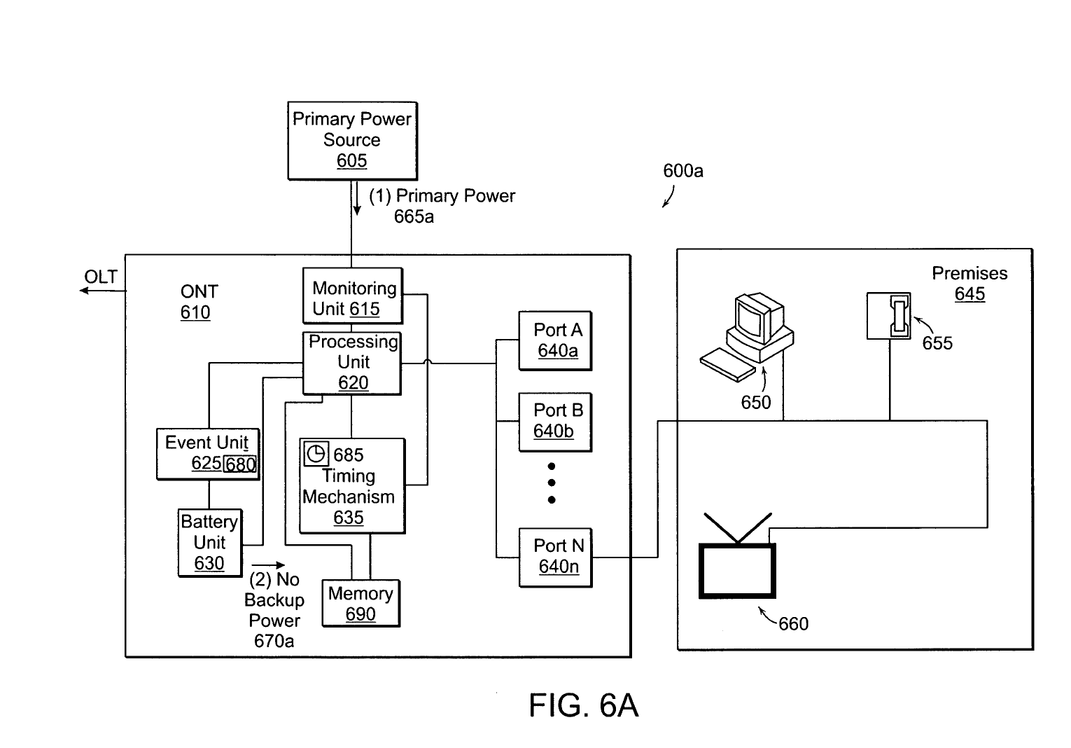

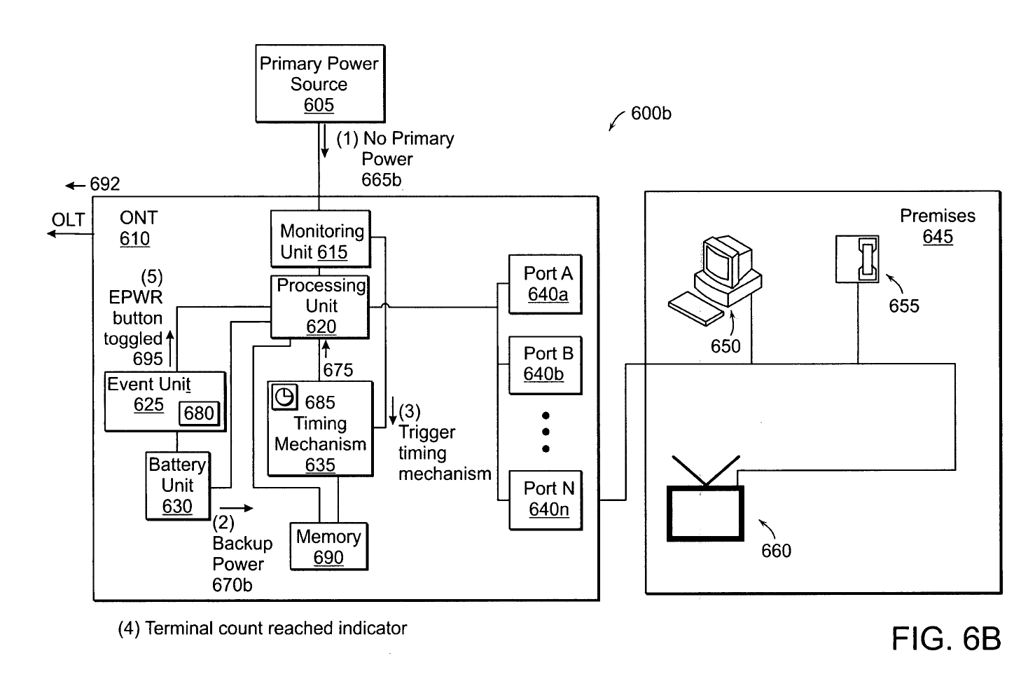

FIGS. 6A and 6B are block diagrams of example Optical Network Terminals (ONTs) 600a, 600b, associated with a primary power source 605 and a customer premises 645, further illustrating normal primary power and interrupted primary power states, respectively, according to example embodiments of the present invention. In FIG. 6A, the ONT 610 includes a monitoring unit 615, processing unit 620, activation unit 625, battery unit 630, timing mechanism 635 having an indicator 685, and memory unit 690. The battery unit 630 may include at least one battery. The ONT 610 may further include multiple ports. For example, the ONT 610 may include ports A-N 640a-n. Ports A-N 640a-n may support technologies such as Ethernet, Wi-Fi, Very-high-bit-rate Digital Subscriber Line (VDSL), Home Phone Line Networking Alliance (HPNA), Plain Old Telephone Service (POTS), Home Plug Power Line Alliance, Multi-media over Coax Alliance (MoCA), wireless, and other home network solutions.

Typically, when an end-user desires to purchase communications services, the end-user may contact a service provider and request the communications services. The service provider may then dispatch a technician to the end-user's premises 645 to install the ONT 610 or to set up communications services on an already installed ONT 610. The end-user's premises 645 may include a computer 650, telephone 655, and audiovisual device 660. Before or after the technician installs the ONT 610, the service provider may provision the ONT 610 with configuration information including the serial number of the ONT 610 and a setting to enable a default or specific communications service based on information known to the service provider or provided by the end-user. For example, the service provider may use the management system (not shown) to configure the ONT 610 with a default communications service, such as POTS.

As illustrated in FIG. 6A, typically the ONT 610 receives power 665a by plugging an electrical cord (not shown) into a primary power source 605, such as a wall socket, at the end-user's premises 645. When the primary power source 605 is active 665a, the battery unit 630 does not supply power 670a to the ONT 610. The end-user's premises 645 may experience a loss of power for many reasons, such as a malfunction of a transformer connected to the end-user's premises 645. In the event there is a loss of the primary power 665a, the ONT 610 may employ the battery unit 630 as backup power in an energy-extending manner, as described above in reference to FIG. 5.

As illustrated in FIG. 6B, there may be a loss of power 665b between the ONT 610 and the primary power source 605. Once the monitoring unit 615 detects the loss of power 665b, the monitoring unit 615 may send a signal to a battery unit 630 via a processing unit 620 to activate battery (“backup”) power 670b. The processing unit 620 may also trigger the timing mechanism 635 to time a duration of the ONT's 610 being in the first state of backup power. The first state of backup power may be when the ONT 610 is operating off the battery unit 630. The first state of backup power, for example, may be a state in which the ONT 610 provides only a particular service, such as POTS. The end-user may select other services via a graphical user interface (GUI) (not shown) on the ONT 610. The service provider may also include other default services installed at the manufacturing facility.

An indicator 685 on the timing mechanism 635 may notify the processing unit 620 or operator that the timing mechanism 635 has reached a terminal threshold by sending a notification signal 675 to the processing unit 620 to cause the ONT 610 to enter the second state of backup power. The second state of backup power, in this example, may be the ONT's 610 being in the power OFF mode.

The terminal threshold may be a numerical value (e.g., zero for a count down timer or non-zero for count up timer) or logical setting. The terminal threshold may be a default value loaded at the manufacturer's facility or configured by the end-user via a graphical user interface (GUI) (not shown) on the ONT 610.

An event unit 625 having a switch 680 may be toggled or pressed prior to the timing of the duration reaching the terminal threshold. In response to the switch 680 of the event unit 625 being toggled or pressed, a toggled signal 695 via the processing unit 620 may cause the ONT 610 to enter the second state of backup power. The second state of backup power, in this example, may be the ONT's 610 being in the power OFF mode.

Prior to the ONT 610 entering the power OFF mode, in response to either the timing duration reaching the terminal threshold or the switch 680 being pressed, the ONT 610 may send a “dying gasp” command 692 to the OLT.

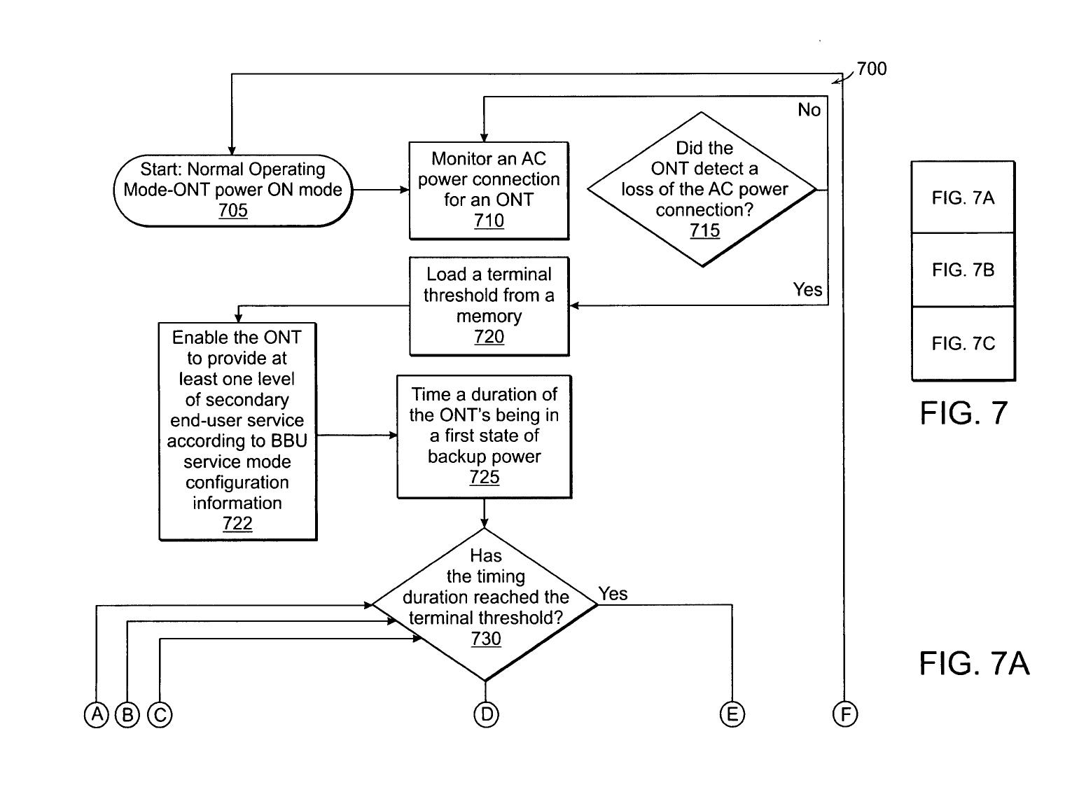

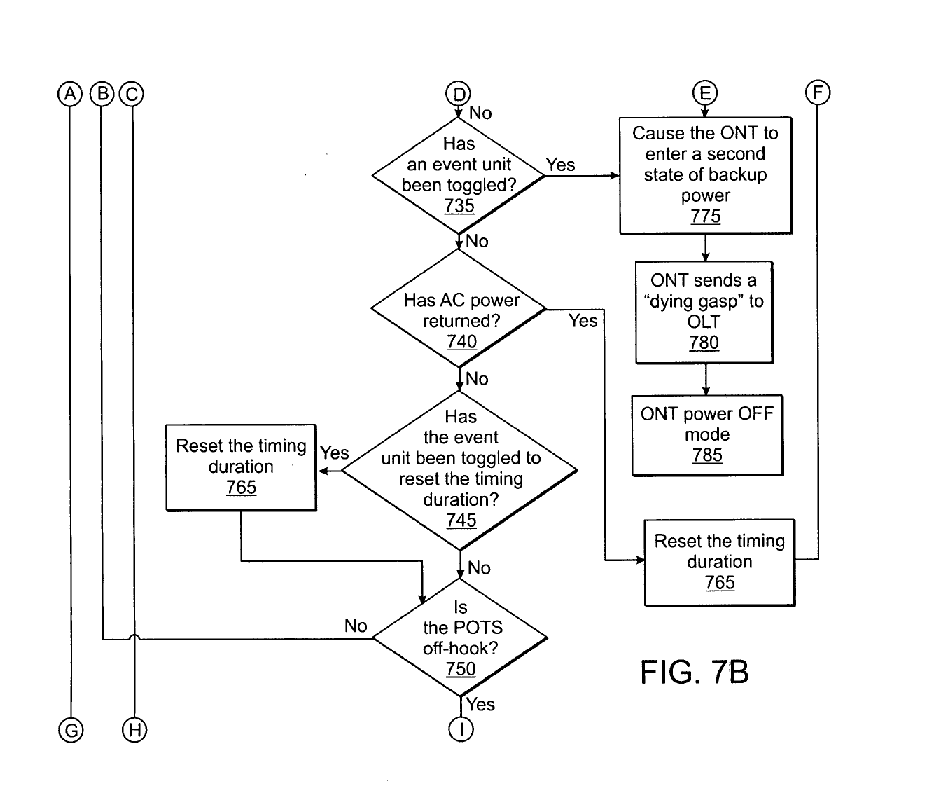

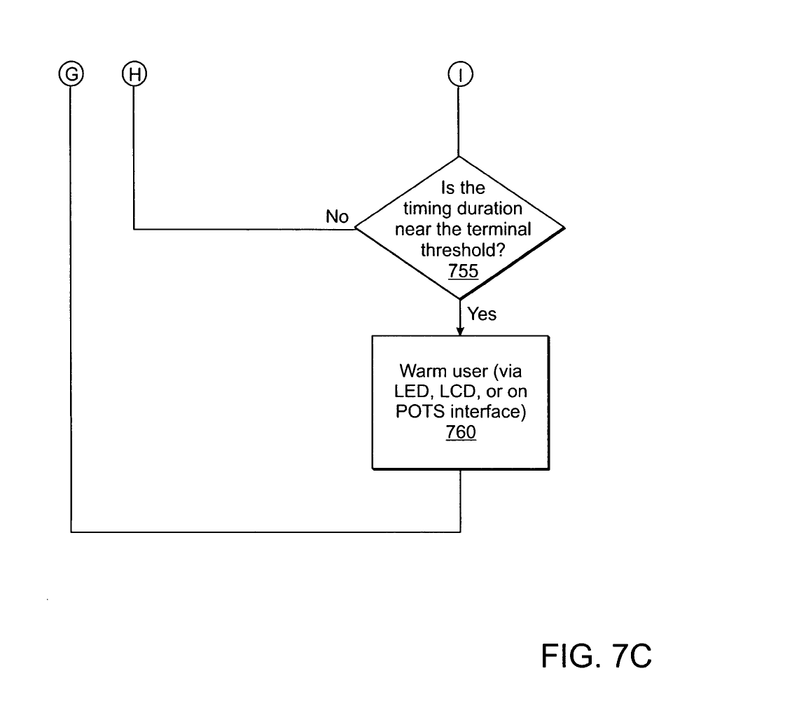

FIG. 7 is an example flow diagram 700 performed in accordance with yet another example embodiment of the present invention. After an ONT is initially in the power ON mode (705), the ONT may monitor for a power connection (710). The ONT may then determine whether it has detected a loss of power connection (715). If the ONT has not detected the loss of power connection, the ONT continues to monitor the power connection (710). However, if the ONT detects a loss of power connection, the ONT may load a terminal threshold from the ONT's memory (720). The ONT may enable at least one level of secondary end-user service according to battery backup unit service mode configuration information (722). The ONT may then time the duration of the ONT's being in the first state of backup power (725). The first state of backup power may be the ONT's being in a low power mode. In the low power mode, the ONT, for example, may provide only a particular service, such as POTS. The end-user may select other services via a graphical user interface (GUI) on the ONT. The service provider may also include other default services installed at the manufacturing facility.

The ONT may determine whether the timing of the duration of the ONT's being in the first state of backup power reaches the terminal threshold (730). If the ONT reaches the terminal threshold (730), the ONT may enter the second state of backup power (775). The second state of backup power may be the ONT's being in the power OFF mode. The ONT may then send a “dying gasp” signal to the Optical Line Terminal (OLT) (780) before powering off (785).

If the ONT has not reached the terminal threshold, the ONT may determine whether an event unit has been activated (735). If the event unit has been activated, the ONT enters the second state of backup power (775). The second state of backup power may be the ONT's being in the power OFF mode. Next, the ONT may send a “dying gasp” signal to the Optical Line Terminal (OLT) (780). The ONT may then turn its power off (785).

If the event unit has not been activated, the ONT may detect if the power connection has been restored (740). If the power connection has been restored, the ONT may reset the timing duration (790) and the ONT re-enters the power ON mode (705) using a primary power source rather than the backup power source. If the power connection has not been restored, the ONT may determine whether the event unit has been toggled to reset the timing duration (745). The event unit may be toggled to reset the timing duration, for example, by a technician pressing a switch. In another example, the technician may enter a specific sequence of digits in the technician's telephone in communication with the ONT to toggle the event unit. The technician may also change the terminal threshold by entering a specific sequence of digits in his or her telephone. The feature of using the telephone to toggle the event unit may or may not be associated with ONTs that do not currently support an event unit switch. If the event unit has been activated, the ONT may reset the timing duration (765). The ONT may then determine if the POTS is off-hook (750).

If the event unit has not been activated, the ONT may determine if the POTS is off-hook (750). If the POTS is not off-hook, the ONT may determine whether the timing of the duration of the ONT's being in the first power state reaches the terminal threshold (730). If the POT is off-hook, the ONT may determine if the timing duration is near the terminal threshold (755). The timing duration is near the terminal threshold, for example, if the timing duration is less than two minutes from reaching the terminal threshold. The ONT may then send a warning signal (760) to a display unit that the ONT will soon enter the second state of backup power, which is, in this example, the power OFF mode or “emergency dial-out only” mode. The display unit may be a light emitting diode (LED), liquid crystal display (LCD), or an electrical signal or visual signal on the POTS interface. Alternatively, the warning signal may be in the form of an audible warning, such as a beeping tone. There may be different stages of audible or LED indications based on the timer and how close the ONT is from shutting down. For example, regular beeping every X1 seconds when the two minute (first timer) triggers, then every X2 seconds when the one minute threshold (second timer) triggers. The X1 interval may be greater than or less than the X2 interval. The ONT may then determine whether the timing of the duration of the ONT's being in the first power state reaches a terminal threshold (730).

If the timing duration, for example, is more than two minutes from reaching the terminal threshold (755), the ONT may then determine whether the timing of the duration of the ONT's being in the first state of backup power reaches the terminal threshold (730).

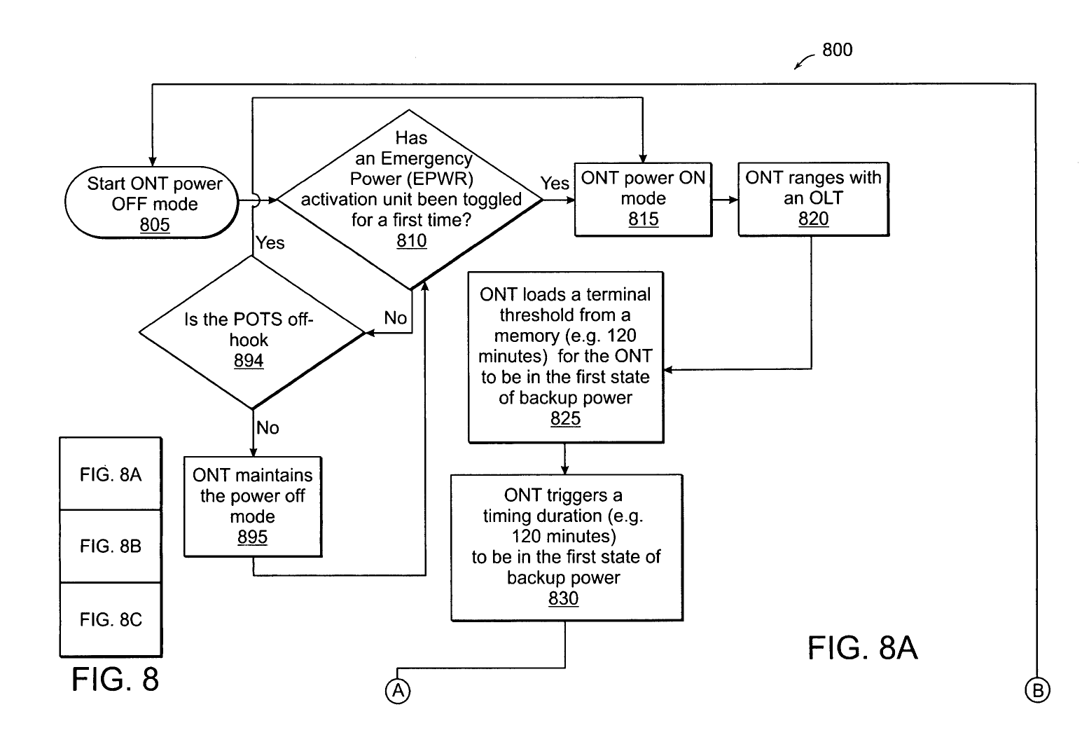

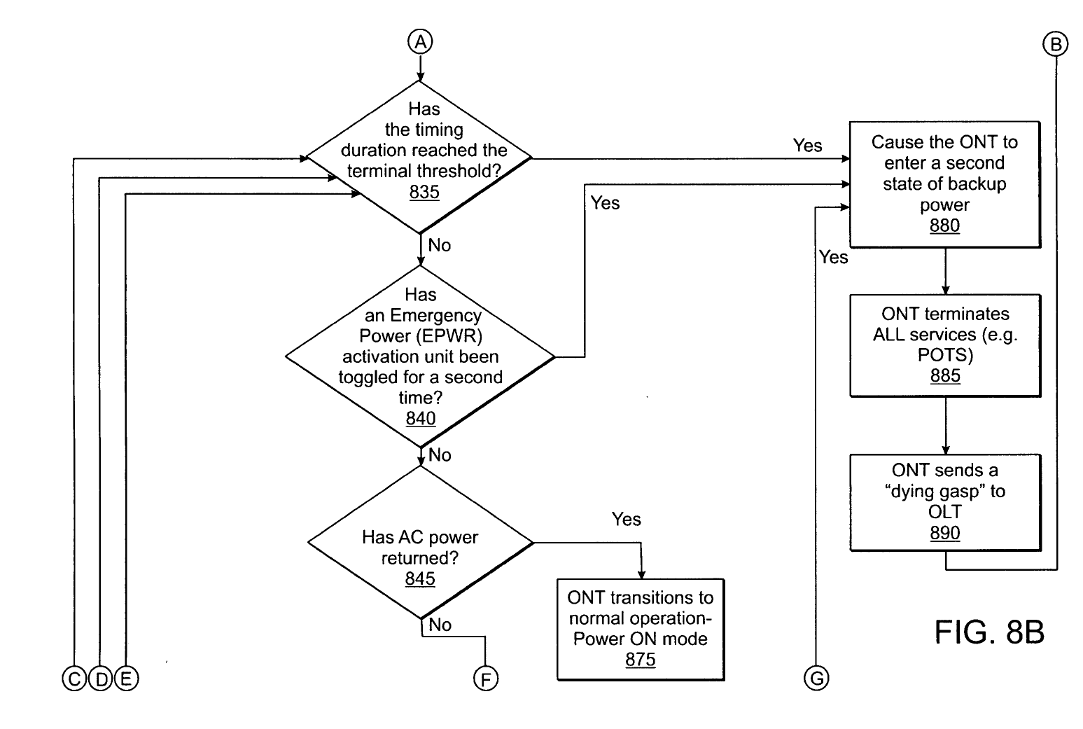

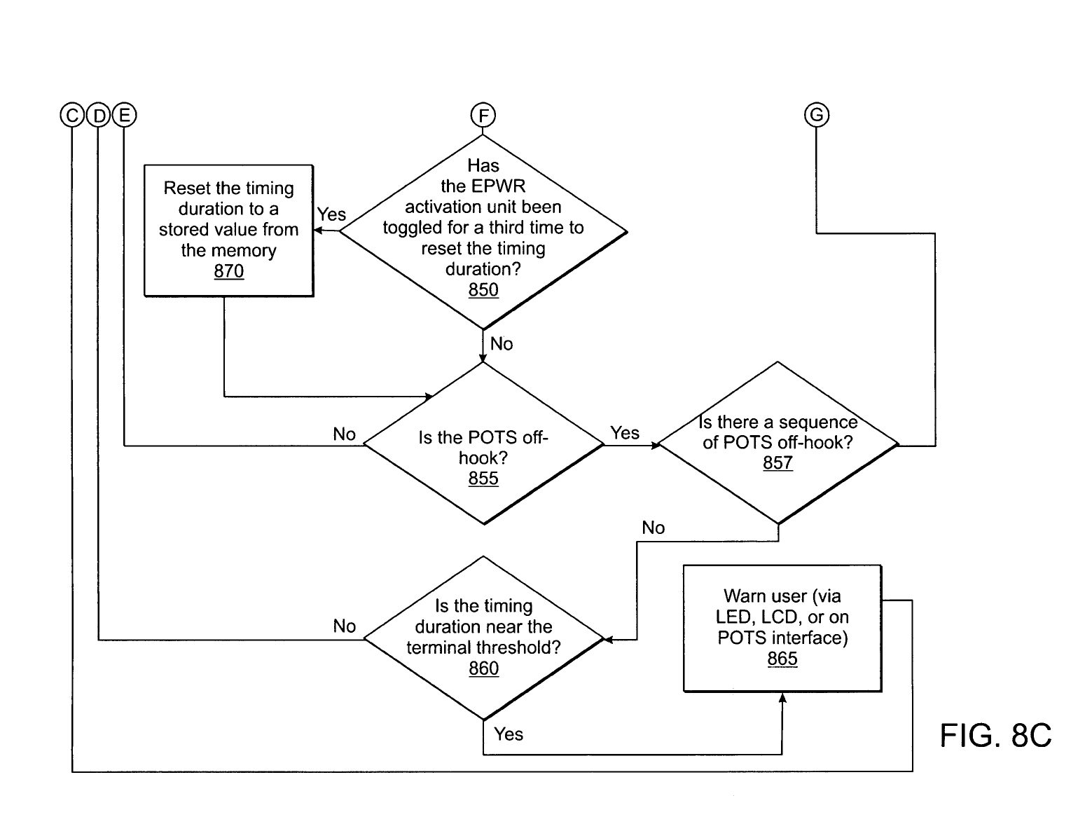

FIG. 8 is an example flow diagram 800 performed in accordance with yet another example embodiment of the present invention. After an ONT is initially in a power OFF mode (805), the ONT may determine whether an event unit (or an Emergency Power (EPWR) activation unit) has been toggled a first time (810). If the EPWR activation unit has not been toggled the first time, the ONT may determine if a POTS device (e.g. telephone) associated with the battery back-up unit under test is off-hook (894), either physically, electrically, or logically. If the POTS device is not off-hook, the ONT may maintain the power OFF mode (895). However, if the POTS device is off-hook, the ONT may enter the power ON mode (815).

If the EPWR activation unit has been toggled the first time (810), the ONT may enter the power ON mode (815). The ONT may then range with an OLT (820) and load a terminal threshold from the ONT memory (825). The terminal threshold may be, for example, 120 minutes, if the terminal threshold is a numeric base. Alternatively, the terminal value may be a logical base rather than a numeric base. Moreover, the terminal threshold may be configured by the end-user or a default setting installed by the manufacturer. The ONT may trigger a timing to be in the first state of backup power (830). The first state of backup power, for example, may be in the power ON mode. In the power On mode, for example, the ONT provides only a particular service, such as POTS. The end-user may select other services via a graphical user interface (GUI) on the ONT. The service provider may also include other default services installed at the manufacturing facility.

The ONT may determine whether the timing of the duration of the ONT's being in the first state of backup power reaches the terminal threshold (835). If the ONT reaches the terminal threshold, the ONT may enter the second state of backup power (880). The second state of backup power, for example, may be the power OFF mode. The ONT may then terminate all services, such as POTS (885). The ONT may send a “dying gasp” command, message, or signal, hereinafter “command,” to the Optical Line Terminal (OLT) (890) before the ONT is in the power OFF mode (805).

If the ONT has not reached the terminal threshold, the ONT may determine whether an Emergency Power (EPWR) activation unit has been toggled a second time (840). If the EPWR activation unit has been toggled a second time, the ONT enters the second state of backup power (880). The second state of backup power, for example, may be the power OFF mode. The ONT may then terminate all services, such as POTS (885). The ONT may send a “dying gasp” command to the Optical Line Terminal (OLT) (890) before being in the power OFF mode (805).

If the EPWR activation unit has not been toggled for the second time, the ONT may detect if the power connection has been restored (845). If the power connection has been restored, the ONT may be in the power ON mode using a primary power connection (875), for example, from the customer premises rather than a backup power source. If the power connection has not been restored, the ONT may determine whether the EPWR activation unit been toggled a third time to reset the timing duration (850). If the EPWR activation unit has been activated, the ONT may reset the timing duration (870). The ONT may then determine if the POTS device is off-hook (855).

If the EPWR activation unit has not been activated a third time, the ONT may determine if the POTS device is off-hook (855). If the POTS device is not off-hook, the ONT may determine whether the timing of the duration of the ONT's being in the first state of backup power reaches the terminal threshold (835). If the POTS device is off-hook, the ONT determines whether there is a sequence of the POTS device off-hook (857). For example, the sequence may be on-hook, off-hook, on-hook, off-hook. It is to be understood that there may other sequences that may also be used. If the ONT determines there is a sequence of off-hooks, the ONT enters the second state of backup power (880). The second state of backup power may be the power OFF mode. If the ONT determines there is not a sequence of off-hooks, the ONT may determine if the timing duration is near the terminal threshold (860). The timing duration is near the terminal threshold, for example, if the timing duration is less than two minutes from reaching the terminal threshold and the ONT may send a warning signal (865) to the display unit that the ONT may soon enter the second state of backup power, which, in this example, is the power OFF mode. The display unit may be a light emitting diode (LED), liquid crystal display (LCD), or an electrical signal or visual signal on the POTS interface. Alternatively, the warning signal may be in the form of a warning tone, such as a beeping tone. The ONT may then determine whether the timing of the duration of the ONT's being in the first state of backup power reaches the terminal threshold (835). If the timing duration is not near the terminal threshold, for example, and is more than two minutes from reaching the terminal threshold (860), the ONT may then determine whether the timing of the duration of the ONT's being in the first state of backup power reaches a terminal threshold (835).

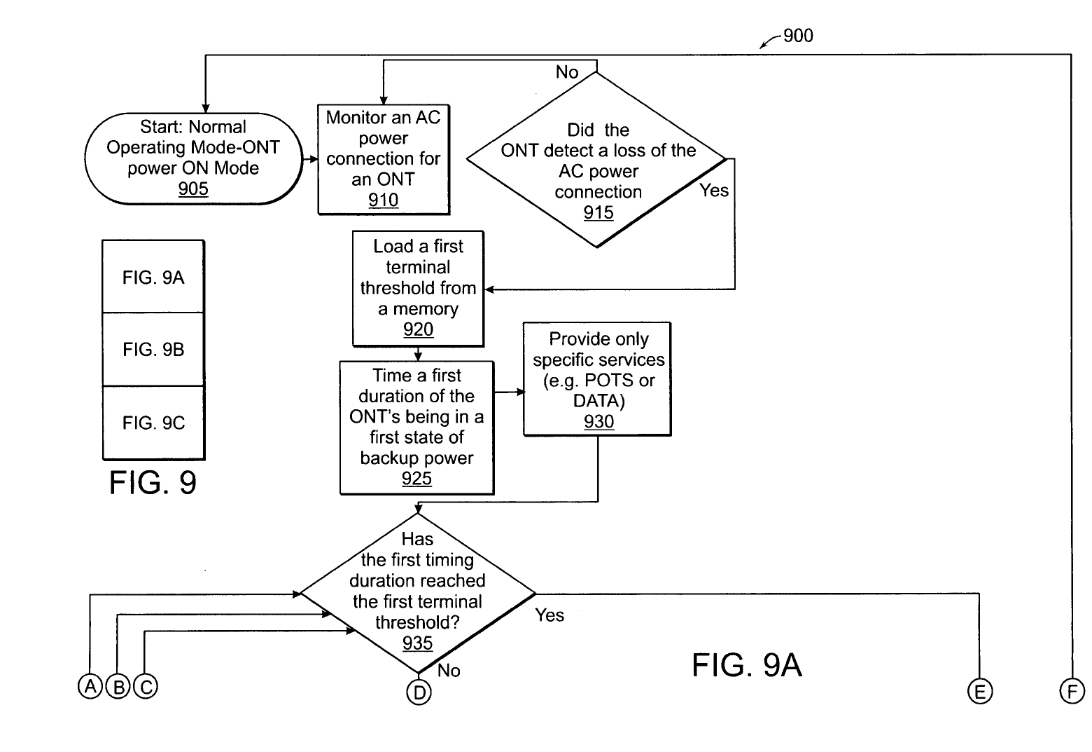

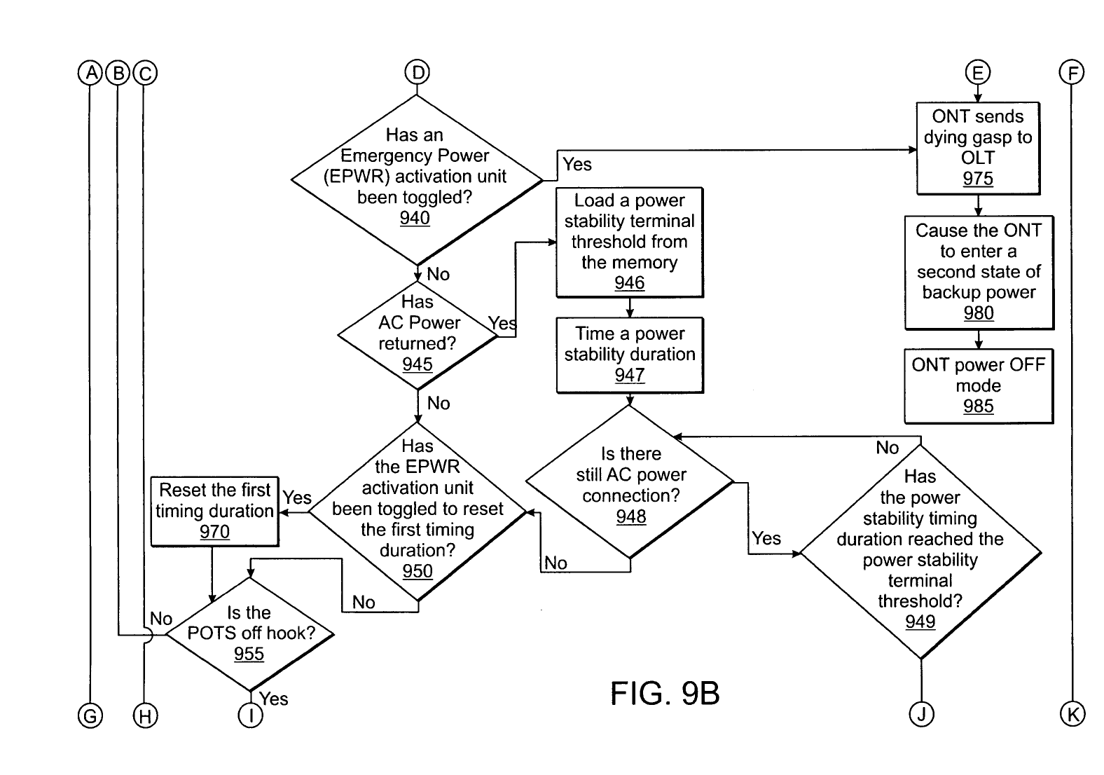

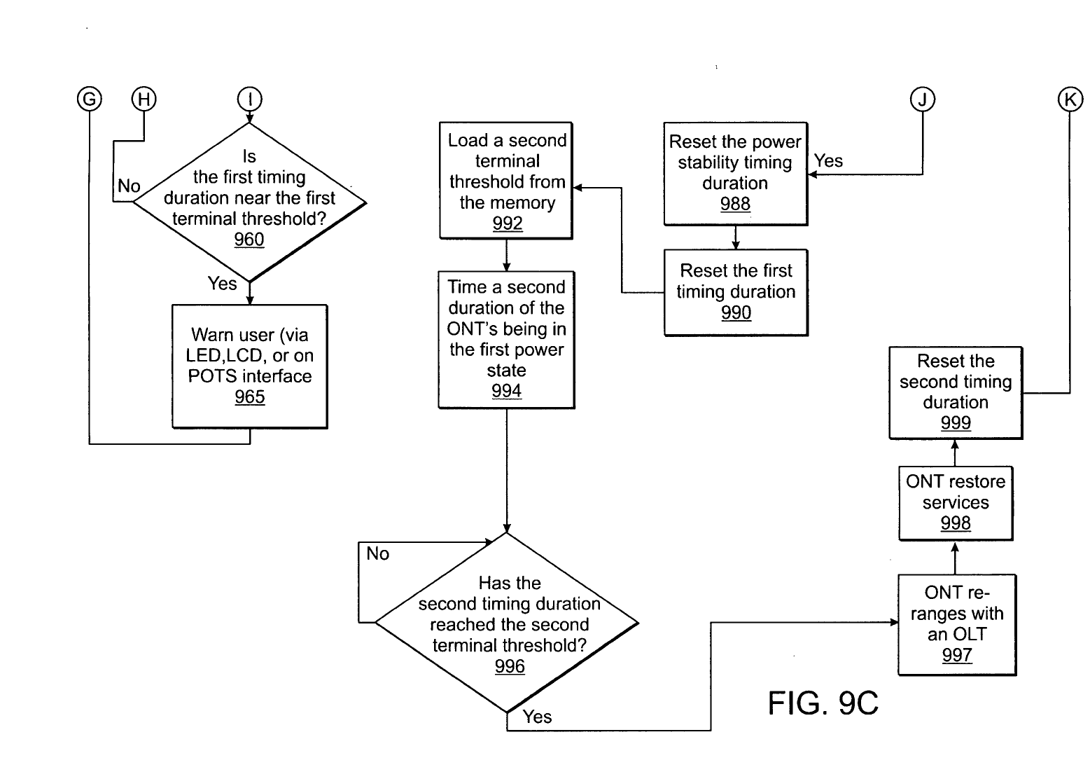

FIG. 9 is an example flow diagram 900 performed in accordance with yet another example embodiment of the present invention. After an ONT is initially in the power ON mode utilizing the primary power source (905), the ONT may monitor for a power connection (910). The power connection may be AC or DC. The power connection may be a power cord on the ONT that may be plugged into an electrical socket. The ONT may then determine whether it has detected a loss of power connection (915). If the ONT has not detected the loss of power connection, the ONT continues to monitor the power connection (910). However, if the ONT detects the loss of power connection, the ONT may load a first terminal threshold from the ONT's memory (920). The ONT may then time the first duration of the ONT's being in the first state of backup power (925). The first state of backup power may be the ONT's being in a low power mode. In the low power mode, the ONT may provide only specific services, such as POTS or DATA (930). The specific type of services may be configured by the end-user via a GUI interface or default services as set-up by the manufacturer. The ONT may determine whether timing the first duration of the ONT's being in the first state of backup power reaches the first terminal threshold (935). If the ONT reaches the first terminal threshold (935), the ONT may send a “dying gasp” command to the Optical Line Terminal (OLT) (975). The ONT may then enter the second state of backup power (980). The second state of backup power may be the ONT's being in the power OFF mode. The ONT may then power off (985).

If the ONT has not reached the first terminal threshold, the ONT may determine whether an event unit (or an Emergency Power (EPWR) activation unit) has been activated (940). If the EPWR activation unit has been activated, the ONT may send a “dying gasp” command to the OLT (975). The ONT may then enter the second power state (980). The second power state may be the ONT's being in the power OFF mode. The ONT may then turn its power off (985). If the EPWR activation unit has not been activated, the ONT may detect if the power connection has been restored (945). If the power connection has been restored, the ONT may load a power stability terminal threshold from the ONT's memory (946). The ONT may then time the power stability duration (947). The ONT may then determine whether there is still an AC power connection (948). If there is no AC power connection, the ONT may determine whether the EPWR activation unit been activated to reset the first timing duration (950).

If there is still an AC power connection, the ONT may determine if the power stability timing duration has reached the power stability threshold (949). If the power stability timing duration reached the power stability threshold, the ONT resets the power stability timing duration (988) and the first timing duration (990). The use of the power stability duration and threshold is to take into account, for example, a situation when the AC power may or may not be 100% stable following a long-term outage. This behavior takes into consideration, for example, when the remaining backup power source may be needed in case the AC power returns temporarily for a couple of seconds, but the AC power outage soon returns for another extended period of time.

The ONT may then load a second power terminal threshold from the ONT's memory (992). The second terminal threshold may be configured by an Ethernet AC restore wait timer. The second terminal threshold may also be configured for the video AC restore wait timer, depending on the type of services. The ONT may time the second duration of the ONT's being in the first state of backup power (994). The first state of backup power may be the low power mode. The ONT may then determine whether timing the second duration reaches the second terminal threshold (996). If the ONT has not reached the second terminal threshold, the ONT continues to determine whether timing the second duration reaches the second terminal threshold (996). If the ONT reaches the second terminal threshold, the ONT may re-range with an Optical Line Terminal (OLT) (997). The ONT may then restore services (998). For example, the ONT may restore all services, including POTS. The type of services may be configured by the end-user via the GUI interface or default services as set-up by the manufacturer. The ONT may then reset the second timing duration (999) before operating in the power ON mode utilizing the primary power source rather than the backup power source (905).

If the power connection has not been restored, the ONT may determine whether the Emergency Power (EPWR) activation unit has been activated to reset the first timing duration (950). The first timing duration may be reset, for example, by a technician pressing a switch. In another example, the technician may enter a specific sequence of digits in his or her telephone to reset the first timing duration. The technician may also change the first terminal threshold by entering a specific sequence of digits in his or her telephone. If the EPWR activation unit has been activated, the ONT may reset the first timing duration (970). The ONT may then determine if the POTS is off-hook (955).

If the EPWR activation unit has not been activated, the ONT may determine if the POTS is off-hook (955). If the POTS is not off-hook, the ONT may determine whether timing the first duration of the ONT's being in the first state of backup power reaches a first terminal threshold (935).

If the POT is off-hook (955), the ONT may determine if the first duration is near the first terminal threshold (960). The first duration is near the first terminal threshold, for example, if the first duration is less than two minutes from reaching the first terminal threshold. The ONT then may send a warning signal (965) to the display unit that the ONT will soon enter the second state of backup power, which in this example is the power OFF mode. The display unit may be a light emitting diode (LED), liquid crystal display (LCD), or an electrical signal on the POTS interface. Alternatively, the warning signal may be in the form of a warning, such as a beeping tone. The ONT may then determine whether the first timing duration of the ONT's being in the first state of backup power reaches the first terminal threshold (935). The first duration is not near the first terminal threshold, for example, if the first duration is more than two minutes from reaching the first terminal threshold (960), and the ONT may then determine whether the first timing duration of the ONT's being in the first state of backup power reaches the first terminal threshold (935).

FIG. 10 is an example diagram 1000 of the various backup power states 1005 versus time or event 1025 in accordance with an embodiment of the present invention. The time or event 1025 may be an on-demand signal, event-driven signal, or timing signal as described in reference to FIGS. 1A, 1B, 3A, 3B, 3C, 4A, 4B, 4C, 6A, and 6B. The ONT may initially operate using primary AC Power 1006 until the ONT experiences a loss of primary power in a first time or event 1030. The ONT may enter the first state of backup power 1010 in response to the first time or event 1030. The first time or event may be a loss of primary power. The first state of backup power 1010 may provide only specific services, such as POTS and DATA. The specific type of service may be configured by the end-user via a GUI interface or default service as set up by the manufacturer. The ONT may remain in the first state of backup power 1010 until a second event 1035. The second event 1035, and subsequent events 1040, 1045, 1050, 1055 may be a toggling of a push button switch (not shown), expiration of a timer, receipt of an automated system command or user command, observation of a diminished battery storage state, and so forth.

The second event 1035 may cause the ONT to enter a second state of backup power 1015. In the second state of backup power 1015, the ONT may provide specific services, if any, such as POTS, but not DATA. The specific type of service may be configured by the end-user via a GUI interface or default services as set up by the manufacturer. The ONT may remain in the second state of backup power 1015 until a third event 1040.

The third event 1040 may cause the ONT to enter a third state of backup power 1020. In the third state of backup power 1020, the ONT may provide no service, such as a sleep mode in this example. However, specific services, if any, such as emergency dial out, may be configured by the end-user via a GUI interface or default services as set up by the manufacturer. The ONT may remain in the third state of backup power 1020 until a fourth event 1045.

The fourth event 1045 may cause the ONT to enter the second state of backup power 1015. In the second state of backup power 1015, the ONT may provide specific services, if any, such as POTS, but not DATA. The specific type of services may be configured by the end-user via a GUI interface or default services as set up by the manufacturer. The ONT may remain in the second state of backup power 1015 until a fifth event 1050.

The fifth event 1050 may cause the ONT to enter the third state of backup power 1020. In this example, the third state of backup power 1020 is a state in which the ONT is in the sleep mode, therefore providing no, or very limited, service. The ONT may remain in the third state of backup power 1020 until a sixth event 1055.

The sixth event 1055 may cause the ONT to enter the first state of backup power 1010. The first state of backup power 1010 may provide only specific services, if any, such as POTS and DATA. It should be understood that there may be more states of backup power and time or event. For example, the fourth state of backup power (not shown) may shut the ONT off. It should also be understood that at any time or event 1025, the ONT may not be in the backup power states 1005, in the event primary power is restored.

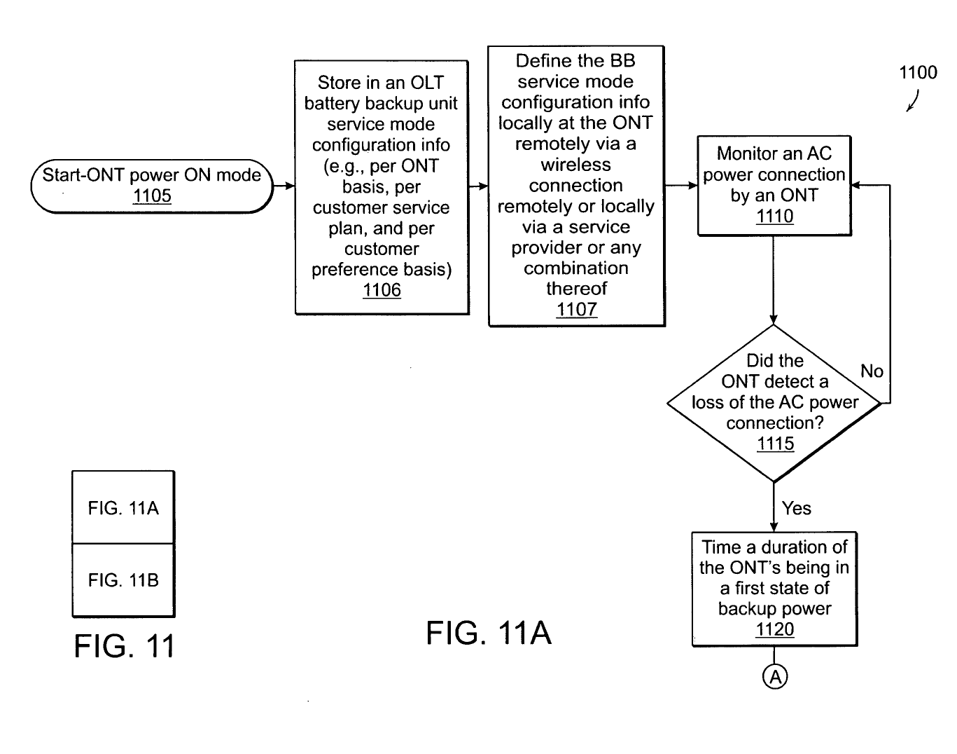

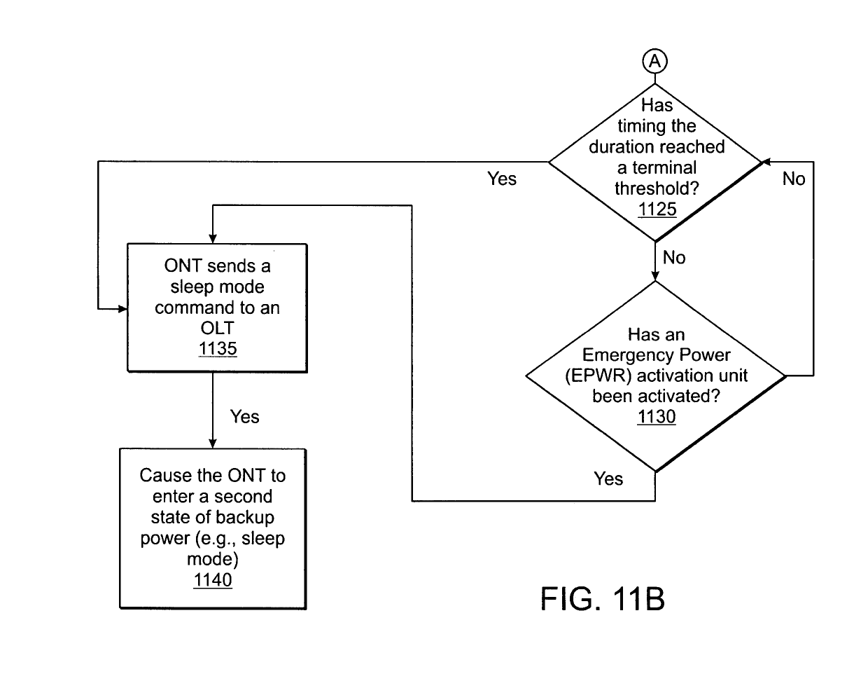

FIG. 11 is an example flow diagram 1100 performed in accordance with yet another example embodiment of the present invention. After an ONT initially enters a power ON mode (1105), the ONT may store in an Optical Line Terminal (OLT) battery backup unit service mode configuration information (1106). The battery backup unit service mode configuration information may be on a per ONT basis, per customer service plan, and per customer preference basis. The battery backup unit service mode configuration information may be defined locally at the ONT, remotely via a wireless connection, remotely or locally via a service provider, or any combinations thereof (1107).

The ONT may monitor for a power connection (1110). The ONT may then determine whether it has detected a loss of power connection (1115). If the ONT has not detected the loss of power connection, the ONT continues to monitor the power connection (1110). However, if the ONT detects a loss of power connection (1115), the ONT may time the duration of the ONT's being in a first state of backup power (1120). In the first state of backup power, the ONT may provide only specific services, such as POTS or DATA. The specific type of services may be configured by the end-user or default services as set up by the manufacturer. Next, the ONT determines whether the timing of the duration of the ONT's being in the first state of backup power reaches a terminal threshold (1125). If the ONT reaches the terminal threshold, the ONT sends a sleep mode command to an OLT (1135). The sleep mode command may be a command in a Physical Layer Operations, Administration and Maintenance (PLOAM) message.

If the ONT has not reached the terminal threshold (1125), the ONT determines whether an event unit (or an Emergency Power (EPWR) activation unit) has been activated (1130). If the EPWR activation unit has not been activated, the ONT continues to determine whether the timing of the duration of the ONT's being in the first state of backup power reaches the terminal threshold (1125). If the EPWR activation unit has been activated, the ONT sends a sleep mode command to an OLT (1135). The sleep mode command may be a command in a Physical Layer Operations, Administration and Maintenance (PLOAM) message. The ONT may then enter a second state of backup power (1140). The second state of backup power in this embodiment is the ONT's being in the sleep mode.

FIG. 12 is an example billing statement 1200 in accordance with an example embodiment of the present invention. The billing statement 1200 may used by a service provider providing services such as data, voice, emergency 9-1-1 service, plain old telephone service (POTS), or video when an ONT is receiving primary power, thus no loss in primary power.

The billing statement 1200 may include a service provider name 1205 and an address 1210 of the service provider 1205. The billing statement 1200 may also include a customer's name 1215 and address 1220, an account number 1225, a date of the bill summary 1230 being generated, and an invoice number 1235 that is associated with the account number 1225. The billing statement 1200 may further include a previous balance 1240, a payment 1245 that was received by the service provider 1205, and a balance forward amount 1250. The billing statement 1200 may further include a current monthly access charge 1255 and a total monthly charge 1260.

FIG. 13 is another example billing statement 1300 in accordance with another example embodiment of the present invention. The billing statement 1300 may be used by a service provider 1303 providing services such as data, voice, emergency 9-1-1 service, plain old telephone service (POTS), or video when an ONT is receiving electrical energy from a battery backup power source as a result of a loss in primary power.

The billing statement 1300 may include a service provider name 1303 and an address 1306 of the service provider 1303. The billing statement 1300 may also include a customer's name 1309 and address 1312, an account number 1315, a date of the bill summary 1318 being generated by the service provider 1303, and an invoice number 1321 that is associated with the account number 1315. The billing statement 1300 may further include a previous balance 1324, a payment 1327 that was received by the service provider 1303, and a balance forward amount 1330. The billing statement 1300 may further include a current monthly access charge 1333 for primary service rendered when the ONT is receiving electrical energy from the primary power source and a monthly access charge for secondary end-user service 1336 when the ONT is receiving electrical energy from the battery backup power unit. A type of service 1334 and the charges 1335 are shown for the services rendered when the ONT is utilizing the primary power 1333 and backup power 1336, respectively. For example, the monthly access charge 1335 for primary power service 1333 is $60. The type of service received may be data, voice, emergency 9-1-1 service, plain old telephone service (POTS), or video.

When the ONT is utilizing the backup power unit, the monthly access charge may be broken down to secondary end-user service levels 1339, 1342, 1345 and the cost 1335 associated with each level 1339, 1342, 1345. For each level (e.g., 1339, 1342, 1345), the end-user picks the type of secondary end-user service(s) 1334 the end-user desires. For example, the end-user may choose the type of service 1334 to be video, emergency 9-1-1 service, and POTs. The charges 1335 associated for Level 1 1339 may be $60. The end-user may choose Level 2 1342 to have emergency 9-1-1 service and POTS as the types of services 1334, and the charges 1335 for Level 2 1342 may be $30. Similarly, the end-user may choose for Level 3 1345 to have no service, thus the ONT is in a sleep mode and the charge 1335 for that is $0. The total monthly access charges 1335 for primary 1333 and secondary services 1336 are $150.

The billing statement 1300 may further include a usage summary 1348 of primary power service 1333. The usage summary 1348 may assist the end-user in choosing the type and level of secondary service 1336. The usage summary 1348 may includes the type of service 1351, a percent based on the previous month 1349, and a cumulative percent based from the beginning of the year 1350. The type of service 1351 may be voice 1354, data 1357, emergency 9-1-1 service 1363, plain old telephone service (POTS) 1366, and video 1360.

FIGS. 14A, 14B, and 14C are example service plans 1400a, 1400b, 1400c in accordance with example embodiments of the present invention. The service provider may offer multiple service plans 1400a, 1400b, 1400c to an end-user during the ONT being in a state of backup power. Typically the ONT receives primary power by plugging an electrical cord into a primary power source. However, the end-user's premises may experience a loss of power for many reasons. When the ONT experiences the loss in primary power, the battery backup unit supplies power to the ONT. A service provider may offer a service plan when the ONT is using the primary power source in addition to the multiple service plans 1400a, 1400b, 1400c when the ONT is experiencing the loss in primary power. The service provider offering the multiple service plans 1400a, 1400b, 1400c may associate a state (e.g., a first state 1411, second state 1412, third state 1413, fourth state 1414) of backup power 1410 to a backup power level 1415 and at least one type of service 1420. The power level 1415 may be high, medium, low, and sleep mode. The at least one type of service 1420 may be data, voice, emergency 9-1-1 service, POTS, and video. The service provider may collect a fee 1422 for offering the multiple service plans 1400a, 1400b, 1400c.

The cost or fee 1422 may be based on a variety of method. For example, the fee 1422 may be collected on a subscription service fee basis (e.g., Gold 1406, Platinum 1407, Silver 1408). Other examples include on a per sub-network basis (e.g., FIG. 1B ODN 104n), per ONT basis (e.g., FIG. 1B 106a), per OLT basis (e.g., FIG. 1B 102), per battery backup unit manufacturer basis, per backup power level (e.g., high backup power level 1415), and from another service provider.

The multiple service plans 1400a, 1400b, 1400c may be selected by an end-user. For example, the end-user may choose the Gold Service Plan 1406 that costs $50/month 1422. In the first state of backup power 1411, the ONT utilizing power from a battery backup unit may have a high power level 1416. In the high power level 1416, the ONT may provide data, voice, emergency 9-1-1 service, POTS, and video. In a second state of backup power 1412 which may correspond to a medium power level 1417, the type of service 1420 may be similar to the first state of backup power 1411, but without data. In a third state of backup power 1413, the power level 1415 may be low 1418. The type of service 1420 may be only POTS and emergency 9-1-1 service. In a fourth state of backup power 1414, the power level. 1415 may be a sleep mode 1419. In the sleep mode 1419, the ONT may provide only emergency 9-1-1 service.

The multiple service plans 1400a, 1400b, 1400c may include other information, such as battery backup unit service mode configuration information. For example, the battery backup unit service mode configuration information may include the terminal threshold for the timing mechanism as discussed above.

Another example of a type service plan 1405 may be a Platinum Service Plan 1407 that costs $40/month 1422 as shown in FIG. 14B. The Platinum Service Plan 1407 may be less expensive than the Gold Service Plan 1406 because in the first state of backup power 1411, the ONT may provide only voice, emergency 9-1-1 service, POTS, and video. Data may not be provided under the Platinum Service Plan 1407.

In yet another example of the type service plan 1405 may be a Silver Service Plan 1408 that costs $20/month 1422 as shown in FIG. 14C. The Silver Service Plan 1408 may include only two states of backup power 1410: a first state 1411 and second state 1412. In the first state 1411, the ONT may provide POTS and emergency 9-1-1 service. In the second state 1412, the ONT may only provide emergency 9-1-1 service. Voice, data, and other services may not be included in the Silver Service Plan; therefore, this plan may be less expensive than the Platinum 1407 and Gold 1406 Service Plans. It should be understood that there may be other service plans with different number of backup power states 1410 and type and combination of services 1420.

The multiple service plans 1400a, 1400b, 1400c may be stored at the ONT. The OLT may be in communication with the ONT as discussed above, for example in FIG. 1B. The multiple service plans 1400a, 1400b, 1400c may then be stored at the backup power mode database of the OLT.

While this invention has been particularly shown and described with references to example embodiments thereof, it will be understood by those skilled in the art that various changes in form and details may be made therein without departing from the scope of the invention encompassed by the appended claims.

It should be understood that the terminal threshold may define any lengths of time (e.g., 5 seconds, 30 minutes, or 120 minutes) during which the ONT maintains itself in a power ON mode; power OFF mode; first, second, or at least one third backup power state. The terminal threshold may be set, for example, in accordance with the requirements of the service provider or to account for the various situations that may arise. The terminal threshold may be set up by the end-user via a graphical user interface. The terminal threshold may be determined in some embodiments according to a logic base, algorithm, or mathematical Boolean algebra.

It should be further understood that the timing mechanisms may be implemented as count-up timers; count-down timers; analog timers, such as discharging of a capacitor or other storage elements; or any form of timing mechanisms that can be used to time a duration of the ONT's being in the power ON mode; power OFF mode; first, second, or at least one third backup power state. The timing mechanism may also be based on logic or a mathematical equation. Also, the timing mechanism may be implemented as a single timer or combination of multiple timers. The single timer may include an indicator that indicates when the timer has reached any number of terminal thresholds. Various embodiments may include any number of timing mechanisms and any number of associated terminal thresholds. It should be understood that there may be more than one timing mechanism or terminal threshold.

It should be further understood that in other embodiments, if the ONT is in a power OFF mode, for example the power OFF modes of FIG. 5 (550) or FIG. 7 (785), the ONT may start at 805 of flowchart 800.

It should be further understood that any of the above-described flow diagrams of FIGS. 2, 5, 7, 8, 9, and 11 or underlying methods used to implement aspects related to the networks of FIGS. 3A, 3B, 3C, 4A, 4B, 4C, 6A, and 6B may be implemented in the form of hardware, firmware, or software. If implemented in software, the software may be in any suitable form of software that can be stored on any form of machine-readable medium (e.g., CD-ROM, floppy disk, tape, random access memory (RAM), read-only memory (ROM), optical disk, magnetic disk, FLASH memory, system memory, and hard drive), and loaded and executed by at least one general purpose or application specific processor. The software may be downloaded to nodes in a network via any form of network link including wired, wireless, or optical links, and via any form of communications protocol.

It should be further understood that the flow diagrams of FIGS. 2, 5, 7, 8, 9, and 11 are merely examples, and other configurations, arrangements, additional blocks, fewer blocks, and so forth are possible in other embodiments.

It should be further understood that the PON can be other network types, and the ONT can be any form of network node in a network employing a power backup unit, such as a battery backup unit or other power storage device (e.g., capacitor) backup unit.

It should be further understood that the GUI or other human-to-machine interface may be located at the OLT or other network node in a network.

It should be further understood that the first, second, and at least one third state of backup power may be the power ON, power OFF, or low power mode depending on the various situations that the ONT may encounter.

It should be further understood that toggling the EPWR switch while the ONT is in active power mode (e.g., low power mode using backup power source; power ON mode using primary power source, or power OFF mode) may perform other specific commands beside the active power mode or reset the timing duration. Other specific commands, for example, may be toggling the EPWR switch once does nothing; toggling it twice within one second activates specific services; toggling it three times within one second can activate other services.

It should be further understood that the switch in the activation unit may be a mechanical, electrical, electromechanical, or electro-optic switch. Moreover, the switch may be rotary, selector type, toggle, or pushbutton switches, for example. Select and toggle switches may or may not be ‘maintain contact’ type. Pushbutton may be momentary or maintain contact type. Further, the switch may not be a physical device, but may be based on logic or mathematical algorithms.

It should be further understood that the ONT may send other types of commands besides the “dying gasp” command and sleep mode command. The ONT may then enter the respective state that corresponds to such a command.

What is claimed is:

1. A method of providing backup power for an Optical Network Terminal (ONT) in a Passive Optical Network (PON), the method comprising:
entering a first state of backup power in an event of a loss of primary power to the ONT;
monitoring a state of a backup power activation signal enabled to be activated in the event of the loss of primary power to the ONT; and
causing the ONT to enter a second state of backup power in response to the backup power activation signal being in an active state.

2. The method according to claim 1 further including storing in an Optical Line Terminal (OLT) battery backup unit service mode configuration information.

3. The method according to claim 2 wherein storing the battery backup unit service mode configuration information is selected from a group consisting of: a per ONT basis, per customer service plan basis, and per customer preference basis.

4. The method according to claim 2 further including defining the battery backup unit service mode configuration information locally at the ONT, remotely via a wireless connection, remotely or locally via a service provider, or any combinations thereof.

5. The method according to claim 1 further including enabling the ONT to provide at least one level of secondary end-user service according to battery backup unit service mode configuration information.

6. The method according to claim 1 wherein monitoring the state of the backup power activation signal includes:
timing a duration of the ONT's being in the first state of backup power after entering the first state of backup power; and
causing the ONT to enter the second state of backup power in response to the duration reaching a terminal threshold.

7. The method according to claim 6 wherein causing the ONT to enter the second state of backup power includes causing the ONT to enter the state of backup power irrespective of activity by an end-user at the ONT.

8. The method according to claim 1 further including:
causing the backup power activation signal to enter the active state as a function of a timing signal; and
causing the backup power activation signal to enter the active state as a function of an event driven signal.

9. The method according to claim 8 further including causing the event driven signal to enter the active state by identifying a triggering of a power state button.

10. The method according to claim 1 further including causing the ONT to enter at least one third state of backup power in response to the backup power activation signal being in the active state.

11. The method according to claim 1 further including:
changing backup power states upward in the backup power states in response to other events; and
changing a level of at least one level of secondary end-user service according to battery backup unit service mode configuration information in response to changing the backup power states.

12. An apparatus for providing battery backup power to an Optical Network Terminal (ONT) in a Passive Optical Network (PON) comprising:
a backup power logic unit configured to output a backup power activation signal enabled to be activated in an event of a loss of primary power to the ONT; and
a monitoring unit configured to monitor a state of the backup power activation signal, the monitoring unit configured to cause a backup power unit to enter a first state of backup power in response to the backup power activation signal being in an active state.

13. The apparatus according to claim 12 wherein the ONT is configured to be responsive to billing inquiries.

14. The apparatus according to claim 12 further including an Optical Line Terminal (OLT) coupled to the ONT, the OLT including:
a backup power mode database configured to store battery backup unit service mode configuration information, the battery backup unit service mode configuration information including at least one level of secondary end-user service;
a processor configured to process at least one billing inquiry associated with the battery backup unit service mode configuration information; and
a billing database coupled to the processor, the billing database configured to store information to apply to at least one billing statement.

15. The apparatus according to claim 14 wherein the battery backup unit service mode configuration information is selected from a group consisting of: a per ONT basis, per customer service plan basis, and per customer preference basis.

16. The apparatus according to claim 15 wherein the battery backup unit service mode configuration information is configured locally at the ONT, remotely via a wireless connection, locally or remotely via a service provider, or any combinations thereof.

17. The apparatus according to claim 14 wherein the OLT is configured to be responsive to billing inquiries.

18. The apparatus according to claim 12 wherein the backup power activation signal is an Emergency Power (EPWR) signal internal to the ONT.

19. The apparatus according to claim 12 further including:
a timing mechanism configured to time a duration of the ONT's being in the first state of backup power after entering the first state of backup power, the timing mechanism being further configured to activate the backup power activation signal in response to the duration reaching a terminal threshold; and
the monitoring unit configured to cause the backup power unit to enter a second state of backup power in response to the activation signal being in the active state.

20. The apparatus according to claim 19 wherein the monitoring unit is further configured to cause the backup power unit to enter at least one third state of backup power in response to the backup power activation signal being in the active state.

21. The apparatus according to claim 19 wherein the monitoring unit causes the backup power unit to enter the second state of backup power irrespective of activity by an end-user device in communication with the ONT.

22. The apparatus according to claim 12 further including:
a timing mechanism configured to cause the backup power activation signal to enter the active state as a function of a timing signal; and
an event unit configured to cause the backup power activation signal to enter the active state as a function of an event driven signal.

23. The apparatus according to claim 22 wherein the event unit includes a power state button configured to trigger the event driven signal to enter the active state.

24. The apparatus according to claim 12 wherein the monitoring unit is further configured to change backup power states upward in the backup power states and to change a level of at least one level of secondary end-user service according to battery backup unit service mode configuration information in response to other events.

25. A method of providing backup power service comprising:
offering multiple service plans to an end-user for services available during an Optical Network Terminal (ONT) being in a state of backup power;
associating at least one backup power level with a respective at least one service based on a battery back-up service plan selected by an end-user; and
collecting a fee corresponding to the battery back-up service plan selected by the end-user.

26. The method according to claim 25 wherein offering the multiple service plans includes offering battery backup unit service mode configuration information.

27. The method according to claim 25 further including storing the multiple service plans in a backup power mode database of an Optical Line Terminal (OLT) in communication with the ONT.

28. The method according to claim 25 further including storing the multiple service plans at the ONT.

29. The method according to claim 25 further including associating a second state of backup power with the backup power level and the at least one type of service.

30. The method according to claim 29 further including associating at least one third state of backup power with the backup power level and the at least one type of service.

31. The method according to claim 30 further including selecting the backup power level from a group of levels consisting of: high, medium, low, and sleep mode.

32. The method according to claim 25 further including enabling the end-user to select the at least one type of service from a group consisting of: data, voice, emergency 9-1-1 service, Plain Old Telephone Service (POTS), and video.

33. The method according to claim 25 wherein collecting the fee for offering the multiple service plans includes collecting the fee on a subscription service fee basis.

34. The method according to claim 25 wherein collecting the fee for offering the multiple service plans includes collecting the fee on a per sub-network basis.

35. The method according to claim 25 wherein collecting the fee for offering the multiple service plans includes collecting the fee on a per ONT basis.

36. The method according to claim 25 wherein collecting the fee for offering the multiple service plans includes collecting the fee on a per Optical Line Terminal (OLT) basis.

37. The method according to claim 25 wherein collecting the fee for offering the multiple service plans includes collecting the fee on a per battery backup unit manufacturer basis.

38. The method according to claim 25 wherein collecting the fee for offering the multiple service plans includes collecting the fee on a per backup power level basis.

39. The method according to claim 25 wherein collecting the fee for offering the multiple service plans includes collecting the fee from a service provider.
